(19) United States
(12) Patent Application Publication
(10) Pub. No.: US 2026/0122277 A1
(43) Pub. Date: Apr. 30, 2026

(54) METHODS TO DESCRIBE THE HIGH-LEVEL SYNTAX DESIGN OF A BITSTREAM CARRYING DATA CODED USING LEARNING-BASED CODEC FOR POINT CLOUD CONTENT

(71) Applicant: InterDigital VC Holdings, Inc., Wilmington, DE (US)

(72) Inventors: Gurdeep Bhullar, Montreal (CA); Dong Tian, Boxborough, MA (US); Jiahao Pang, Plainsboro, NJ (US); Srinivas Gudumasu, Montreal (CA); Ahmed Hamza, Coquitlam (CA)

(21) Appl. No.: 18/933,923

(22) Filed: Oct. 31, 2024

(51) Int. Cl. H04N 19/70; H04N 19/119; H04N 19/174; H04N 19/597; H04N 19/96

(52) U.S. Cl. CPC H04N 19/70; H04N 19/119; H04N 19/174; H04N 19/597; H04N 19/96

(57) ABSTRACT

Some embodiments of a method may include: obtaining an access unit from a point cloud data bitstream; extracting a slice data unit from the access unit, wherein the slice data unit comprises a slice header and a slice payload; determining a slice data unit type for the slice data unit, parsing the slice header based on the slice data unit type; parsing the slice payload based on the slice data unit type; and generating point cloud data using the parsed slice payload.

### INCORPORATION BY REFERENCE

The present application incorporates by reference in their entirety the following applications: U.S. Non-Provisional patent application Ser. No. 18/679,144, entitled “AN END-TO-END LEARNING-BASED POINT CLOUD CODING FRAMEWORK” and filed May 30, 2024 (“144 application”).

### BACKGROUND

The present application is related to point cloud content.

### SUMMARY

A first example method in accordance with some embodiments may include: obtaining an access unit from a point cloud data bitstream; extracting a slice data unit from the access unit, wherein the slice data unit comprises a slice header and a slice payload; determining a slice data unit type for the slice data unit; parsing the slice header based on the slice data unit type; parsing the slice payload based on the slice data unit type; and generating point cloud data using the parsed slice payload.

For some embodiments of the first example method, the slice data unit type is determined to correspond to either geometry data or attribute data.

For some embodiments of the first example method, the slice payload comprises a slice geometry payload.

For some embodiments of the first example method, the slice geometry payload comprises explicit hyperprior data, and the explicit hyperprior data aggregates two or more point cloud features.

For some embodiments of the first example method, the slice payload comprises a slice geometry payload with octree occupancy data.

For some embodiments of the first example method, the slice payload comprises a slice geometry payload organized on a per-depth level basis.

For some embodiments of the first example method, parsing the slice payload comprises splitting the slice payload into two or more sub-slices.

For some embodiments of the first example method, the slice payload comprises a slice attribute payload.

For some embodiments of the first example method, the slice attribute payload comprises explicit hyperprior data and the explicit hyperprior data aggregates two or more attributes.

For some embodiments of the first example method, the slice payload comprises a slice attribute payload with octree occupancy data.

Some embodiments of the first example method further include: obtaining a parameter set from the point cloud data bitstream; extracting a parameter from the parameter set; and configuring a decoder based on the extracted parameter.

For some embodiments of the first example method, generating point cloud data using the parsed slice payload comprises synthesizing hyperprior data using the parsed slice payload.

A first example apparatus in accordance with some embodiments may include: a processor; and a memory storing instructions operative, when executed by the processor, to cause the apparatus to: obtain an access unit from a point cloud data bitstream; extract a slice data unit from the access unit, wherein the slice data unit comprises a slice header and a slice payload; determine a slice data unit type for the slice data unit; parse the slice header based on the slice data unit type; parse the slice payload based on the slice data unit type; and generate point cloud data using the parsed slice payload.

A second example method in accordance with some embodiments may include: obtaining point cloud data; segmenting the point cloud data into one or more data slices; performing a slice assembly process for each of the one or more data slices, wherein the slice assembly process performed for a current slice of the one or more data slices comprises: determining a point cloud data type for the current slice; generating a slice header for the current slice based on the point cloud data type; generating a slice payload for the current slice based on the point cloud data type; and assembling the slice header and the slice payload together as a slice data unit for the current slice; and generating an access unit using one or more of the slice data units.

For some embodiments of the second example method, the slice payload comprises one of a slice geometry payload, a slice geometry payload with octree occupancy, and a slice geometry payload organized on a per-depth level basis.

For some embodiments of the second example method, the slice payload comprises explicit hyperprior data, and the explicit hyperprior data aggregates two or more point cloud features.

For some embodiments of the second example method, the slice payload comprises point cloud data for two or more sub-slices.

For some embodiments of the second example method, the slice payload comprises one of slice geometry data and slice attribute data.

Some embodiments of the second example method further include: obtaining a parameter used for configuring a decoder; and generating a parameter set using the obtained parameter.

Some embodiments of the second example method further include streaming the access unit via a bitstream.

### BRIEF DESCRIPTION OF THE DRAWINGS

The following detailed description will be better understood when read in conjunction with the appended drawings, in which there are shown examples of one or more of the multiple embodiments of the present disclosure. It should be understood, however, that the embodiments described herein are not limited to the precise arrangements and instrumentalities shown in the drawings. In the drawings:

FIG. 1 is a system diagram illustrating an example set of interfaces for a system according to some embodiments.

FIG. 2 is a process diagram illustrating an example coding framework with implicit hyperprior synthesis according to some embodiments.

FIG. 3 is a process diagram illustrating an example coding framework with explicit hyperprior data according to some embodiments.

FIG. 4 is a process diagram illustrating an example attribute encoding framework according to some embodiments.

FIG. 5 is a message structure diagram illustrating an example slice data unit according to some embodiments.

FIG. 6 is a schematic perspective view illustrating an example slice boundary according to some embodiments.

FIG. 7 is a data structure diagram illustrating an example bitstream structure according to some embodiments.

FIG. 8 is a message structure diagram illustrating an example unit payload format according to some embodiments.

FIG. 9 is a flowchart illustrating an example process for parsing a point cloud access unit according to some embodiments.

FIG. 10 illustrates voxels in different levels.

FIG. 11 illustrates example octree encoding using a learning-based method, according to some embodiments.

FIG. 12 illustrates an example feature aggregator (FA) with aggregated feature as input, according to some embodiments.

FIG. 13 illustrates an example feature encoder using hyperprior encoder, according to an embodiment.

FIG. 14 illustrates an example occupancy probability estimator (in encoder and decoder), according to an embodiment.

FIG. 15 illustrates example octree decoding using a learning-based method, according to an embodiment.

FIG. 16 illustrates an example feature decoder using hyperprior decoder, according to an embodiment.

FIG. 17 illustrates feature-based coding in a larger codec system.

FIG. 18 illustrates an example octree coding in a larger codec system, according to an embodiment.

FIG. 19 illustrates another example octree coding in a larger codec system, according to an embodiment.

FIG. 20 illustrates an example FS block, according to an embodiment.

The entities, connections, arrangements, and the like that are depicted in—and described in connection with—the various figures are presented by way of example and not by way of limitation. As such, any and all statements or other indications as to what a particular figure “depicts,” what a particular element or entity in a particular figure “is” or “has,” and any and all similar statements—that may in isolation and out of context be read as absolute and therefore limiting—may only properly be read as being constructively preceded by a clause such as “In at least one embodiment, . . . .” For brevity and clarity of presentation, this implied leading clause is not repeated ad nauseum in the detailed description.

### DETAILED DESCRIPTION

In describing the various embodiments of the present disclosure, certain terminology is used herein for convenience only and should not be considered as limiting such embodiments. In the drawings, the same reference numerals are employed for designating the same elements throughout the several figures and the present description.

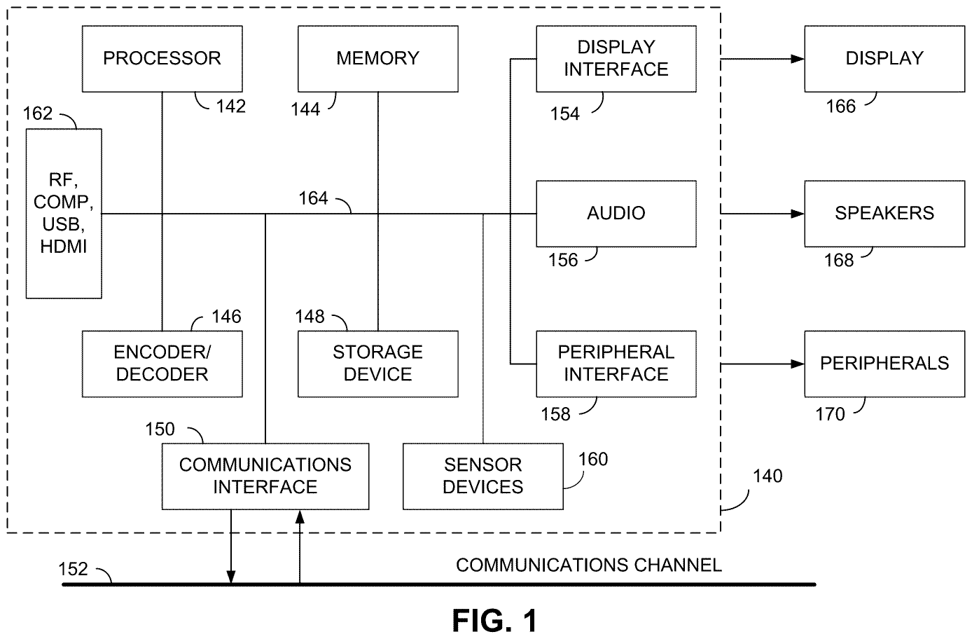

FIG. 1 is a system diagram illustrating an example set of interfaces for a system according to some embodiments. An extended reality display device, together with its control electronics, may be implemented using a system such as the system of FIG. 1. System 140 can be embodied as a device including the various components described below and is configured to perform one or more of the aspects described in this document. Examples of such devices, include, but are not limited to, various electronic devices such as personal computers, laptop computers, smartphones, tablet computers, digital multimedia set top boxes, digital television receivers, personal video recording systems, connected home appliances, and servers. Elements of system 140, singly or in combination, can be embodied in a single integrated circuit (IC), multiple ICs, and/or discrete components. For example, in at least one embodiment, the processing and encoder/decoder elements of system 140 are distributed across multiple ICs and/or discrete components. In various embodiments, the system 140 is communicatively coupled to one or more other systems, or other electronic devices, via, for example, a communications bus or through dedicated input and/or output ports. In various embodiments, the system 140 is configured to implement one or more of the aspects described in this document.

The system 140 includes at least one processor 142 configured to execute instructions loaded therein for implementing, for example, the various aspects described in this document. Processor 142 may include embedded memory, input output interface, and various other circuitries as known in the art. The system 140 includes at least one memory 144 (e.g., a volatile memory device, and/or a non-volatile memory device). System 140 may include a storage device 148, which can include non-volatile memory and/or volatile memory, including, but not limited to, Electrically Erasable Programmable Read-Only Memory (EEPROM), Read-Only Memory (ROM), Programmable Read-Only Memory (PROM), Random Access Memory (RAM), Dynamic Random Access Memory (DRAM), Static Random Access Memory (SRAM), flash, magnetic disk drive, and/or optical disk drive. The storage device 148 can include an internal storage device, an attached storage device (including detachable and non-detachable storage devices), and/or a network accessible storage device, as non-limiting examples.

System 140 includes an encoder/decoder module 146 configured, for example, to process data to provide an encoded video or decoded video, and the encoder/decoder module 146 can include its own processor and memory. The encoder/decoder module 146 represents module(s) that can be included in a device to perform the encoding and/or decoding functions. As is known, a device can include one or both of the encoding and decoding modules. Additionally, encoder/decoder module 146 can be implemented as a separate element of system 140 or can be incorporated within processor 142 as a combination of hardware and software as known to those skilled in the art.

Program code to be loaded onto processor 142 or encoder/decoder 146 to perform the various aspects described in this document can be stored in storage device 148 and subsequently loaded onto memory 144 for execution by processor 142. In accordance with various embodiments, one or more of processor 142, memory 144, storage device 148, and encoder/decoder module 146 can store one or more of various items during the performance of the processes described in this document. Such stored items can include, but are not limited to, the input video, the decoded video or portions of the decoded video, the bitstream, matrices, variables, and intermediate or final results from the processing of equations, formulas, operations, and operational logic.

In some embodiments, memory inside of the processor 142 and/or the encoder/decoder module 146 is used to store instructions and to provide working memory for processing that is needed during encoding or decoding. In other embodiments, however, a memory external to the processing device (for example, the processing device can be either the processor 142 or the encoder/decoder module 142) is used for one or more of these functions. The external memory can be the memory 144 and/or the storage device 148, for example, a dynamic volatile memory and/or a non-volatile flash memory. In several embodiments, an external non-volatile flash memory is used to store the operating system of, for example, a television. In at least one embodiment, a fast external dynamic volatile memory such as a RAM is used as working memory for video coding and decoding operations, such as for MPEG-2 (MPEG refers to the Moving Picture Experts Group, MPEG-2 is also referred to as ISO/IEC 13818, and 13818-1 is also known as H.222, and 13818-2 is also known as H.262), HEVC (HEVC refers to High Efficiency Video Coding, also known as H.265 and MPEG-H Part 2), or VVC (Versatile Video Coding, a new standard being developed by JVET, the Joint Video Experts Team).

The input to the elements of system 140 can be provided through various input devices as indicated in block 162. Such input devices include, but are not limited to, (i) a radio frequency (RF) portion that receives an RF signal transmitted, for example, over the air by a broadcaster, (ii) a Component (COMP) input terminal (or a set of COMP input terminals), (iii) a Universal Serial Bus (USB) input terminal, and/or (iv) a High Definition Multimedia Interface (HDMI) input terminal. Other examples, not shown in FIG. 1, include composite video.

In various embodiments, the input devices of block 162 have associated respective input processing elements as known in the art. For example, the RF portion can be associated with elements suitable for (i) selecting a desired frequency (also referred to as selecting a signal, or band-limiting a signal to a band of frequencies), (ii) downconverting the selected signal, (iii) band-limiting again to a narrower band of frequencies to select (for example) a signal frequency band which can be referred to as a channel in certain embodiments, (iv) demodulating the downconverted and band-limited signal, (v) performing error correction, and (vi) demultiplexing to select the desired stream of data packets. The RF portion of various embodiments includes one or more elements to perform these functions, for example, frequency selectors, signal selectors, band-limiters, channel selectors, filters, downconverters, demodulators, error correctors, and demultiplexers. The RF portion can include a tuner that performs various of these functions, including, for example, downconverting the received signal to a lower frequency (for example, an intermediate frequency or a near-baseband frequency) or to baseband. In one set-top box embodiment, the RF portion and its associated input processing element receives an RF signal transmitted over a wired (for example, cable) medium, and performs frequency selection by filtering, downconverting, and filtering again to a desired frequency band. Various embodiments rearrange the order of the above-described (and other) elements, remove some of these elements, and/or add other elements performing similar or different functions. Adding elements can include inserting elements in between existing elements, such as, for example, inserting amplifiers and an analog-to-digital converter. In various embodiments, the RF portion includes an antenna.

Additionally, the USB and/or HDMI terminals can include respective interface processors for connecting system 140 to other electronic devices across USB and/or HDMI connections. It is to be understood that various aspects of input processing, for example, Reed-Solomon error correction, can be implemented, for example, within a separate input processing IC or within processor 142 as necessary. Similarly, aspects of USB or HDMI interface processing can be implemented within separate interface ICs or within processor 142 as necessary. The demodulated, error corrected, and demultiplexed stream is provided to various processing elements, including, for example, processor 142, and encoder/decoder 146 operating in combination with the memory and storage elements to process the datastream as necessary for presentation on an output device.

Various elements of system 140 can be provided within an integrated housing, Within the integrated housing, the various elements can be interconnected and transmit data therebetween using suitable connection arrangement 164, for example, an internal bus as known in the art, including the Inter-IC (I2C) bus, wiring, and printed circuit boards.

The system 140 includes communication interface 150 that enables communication with other devices via communication channel 152. The communication interface 150 can include, but is not limited to, a transceiver configured to transmit and to receive data over communication channel 152. The communication interface 150 can include, but is not limited to, a modem or network card and the communication channel 152 can be implemented, for example, within a wired and/or a wireless medium.

Data is streamed, or otherwise provided, to the system 140, in various embodiments, using a wireless network such as a Wi-Fi network, for example IEEE 802.11 (IEEE refers to the Institute of Electrical and Electronics Engineers). The Wi-Fi signal of these embodiments is received over the communications channel 152 and the communications interface 150 which are adapted for Wi-Fi communications. The communications channel 152 of these embodiments is typically connected to an access point or router that provides access to external networks including the Internet for allowing streaming applications and other over-the-top communications. Other embodiments provide streamed data to the system 140 using a set-top box that delivers the data over the HDMI connection of the input block 162. Still other embodiments provide streamed data to the system 140 using the RF connection of the input block 162. As indicated above, various embodiments provide data in a non-streaming manner. Additionally, various embodiments use wireless networks other than Wi-Fi, for example a cellular network or a Bluetooth network.

The system 140 can provide an output signal to various output devices, including a display 166, speakers 168, and other peripheral devices 170. The display 166 of various embodiments includes one or more of, for example, a touchscreen display, an organic light-emitting diode (OLED) display, a curved display, and/or a foldable display. The display 166 can be for a television, a tablet, a laptop, a cell phone (mobile phone), or other device. The display 166 can also be integrated with other components (for example, as in a smart phone), or separate (for example, an external monitor for a laptop). The other peripheral devices 170 include, in various examples of embodiments, one or more of a stand-alone digital video disc (or digital versatile disc) (DVR, for both terms), a disk player, a stereo system, and/or a lighting system. Various embodiments use one or more peripheral devices 170 that provide a function based on the output of the system 140. For example, a disk player performs the function of playing the output of the system 140.

In various embodiments, control signals are communicated between the system 140 and the display 166, speakers 168, or other peripheral devices 170 using signaling such as AV.Link, Consumer Electronics Control (CEC), or other communications protocols that enable device-to-device control with or without user intervention. The output devices can be communicatively coupled to system 140 via dedicated connections through respective interfaces 154, 156, and 158. Alternatively, the output devices can be connected to system 140 using the communications channel 152 via the communications interface 150. The display 166 and speakers 168 can be integrated in a single unit with the other components of system 140 in an electronic device such as, for example, a television. In various embodiments, the display interface 154 includes a display driver, such as, for example, a timing controller (T Con) chip.

The display 166 and speaker 168 can alternatively be separate from one or more of the other components, for example, if the RF portion of input 162 is part of a separate set-top box. In various embodiments in which the display 166 and speakers 168 are external components, the output signal can be provided via dedicated output connections, including, for example, HDMI ports, USB ports, or COMP outputs.

The system 140 may include one or more sensor devices 160. Examples of sensor devices that may be used include one or more GPS sensors, gyroscopic sensors, accelerometers, light sensors, cameras, depth cameras, microphones, and/or magnetometers. Such sensors may be used to determine information such as user's position and orientation. Where the system 140 is used as the control module for an extended reality display (such as control modules), the user's position and orientation may be used in determining how to render image data such that the user perceives the correct portion of a virtual object or virtual scene from the correct point of view. In the case of head-mounted display devices, the position and orientation of the device itself may be used to determine the position and orientation of the user for the purpose of rendering virtual content. In the case of other display devices, such as a phone, a tablet, a computer monitor, or a television, other inputs may be used to determine the position and orientation of the user for the purpose of rendering content. For example, a user may select and/or adjust a desired viewpoint and/or viewing direction with the use of a touch screen, keypad or keyboard, trackball, joystick, or other input. Where the display device has sensors such as accelerometers and/or gyroscopes, the viewpoint and orientation used for the purpose of rendering content may be selected and/or adjusted based on motion of the display device.

The embodiments can be carried out by computer software implemented by the processor 142 or by hardware, or by a combination of hardware and software. As a non-limiting example, the embodiments can be implemented by one or more integrated circuits. The memory 144 can be of any type appropriate to the technical environment and can be implemented using any appropriate data storage technology, such as optical memory devices, magnetic memory devices, semiconductor-based memory devices, fixed memory, and removable memory, as non-limiting examples. The processor 142 can be of any type appropriate to the technical environment, and can encompass one or more of microprocessors, general purpose computers, special purpose computers, and processors based on a multi-core architecture, as non-limiting examples.

### Scene Description Framework for XR

In some embodiments, examples disclosed herein may be used in the domain of rendering of extended reality scene description and extended reality rendering. For some embodiments, for example, the present application may be applied in the context of the formatting and the playing of extended reality applications when rendered on end-user devices such as mobile devices or Head-Mounted Displays (HMD). For some example embodiments, gITF material may be rendered in a 3D environment that is rendered through a 2D screen. The examples presented herein in accordance with some embodiments are not limited to XR applications.

In XR applications, a scene description is used to combine explicit and easy-to-parse description of a scene structure and some binary representations of media content.

In time-based media streaming, the scene description itself can be time-evolving to provide the relevant virtual content for each sequence of a media stream. For instance, for advertising purpose, a virtual bottle can be displayed during a video sequence where people are drinking.

This kind of behavior can be achieved by relying on the framework defined in the Scene Description for MPEG media document, Information technology—Coded representation of immersive media—Part 14: Scene Description for MPEG media, ISO/IEC DIS 23090-14:2021 (E). A scene update mechanism based on the JSON Patch protocol as defined in IETF RFC 6902 may be used to synchronize virtual content to MPEG media streams.

The embodiments described herein are not limited to any particular type or structure of XR display device.

A User Equipment (UE) may correspond to any extended Reality (XR) device/node which may come in variety of form factors. Typical UE (e.g., XR UE) may include, but not limited to the following: Head Mounted Displays (HMD), optical see-through glasses and video see-through HMDs for Augmented Reality (AR) and Mixed Reality (MR), mobile devices with positional tracking and camera, wearables etc. In addition to the above, several different types of XR UE may be envisioned based on XR device functions for e.g., as display, camera, sensors, sensor processing, wireless connectivity, XR/Media processing, and power supply, to be provided by one or more devices, wearables, actuators, controllers and/or accessories. One or more device/nodes/UEs may be grouped into a collaborative XR group for supporting any of XR applications/experience/services.

Point cloud content represents a 3D objects/scene with 3D points. Each point P is characterized by its position in space typically indicated by cartesian coordinates Pₓ, P_{y}, and P_{z}. Along with the positions of the 3D points, additional information or attributes may be associated with a point. Such attributes may correspond to the color, reflectance, intensity, or more characteristics per point.

A point cloud content may be compressed, resulting in a reduction of asset size. The reduced size may be beneficial for applications, such as transmission, streaming, and storage. With the advent of AI-methods and their use in compression, researchers have started to investigate methods to compress point cloud content using AI. With its popularity, MPEG 3DG WG07 has initiated a Call for Proposal (CfP) on the topic of AI-based Point Cloud Compression (AI-PCC). As such, a functional bitstream design that corresponds to the architecture of the AI-PCC codec is needed.

The '144 application describes an architecture and methods to encode point clouds in a tree structure. The encoder utilizes finer level details to extract more powerful features. The extracted features are encoded into a bitstream to benefit the decoder. The decode decodes the features instead of computing them by itself.

Some embodiments of the present application share the backbone to code features for both feature-based coding and octree-based coding. This methodology results in a unified coding framework, which in turn allows for simplicity and may result in wider adoption of the architecture. This methodology also may result in lower memory requirements.

### Spatial Segmentation of the Content

Point cloud (PC) content may be spatially segmented into smaller regions. One of the objectives of spatially segmenting the content is to allow parallelism in the encoding and decoding stages, in which smaller regions may be encoded/decoded independently. A region may or may not depend on other regions for decoding. Furthermore, this methodology enables viewport-adaptive streaming, in which regions in the viewport of the viewer may be streamed independently without the need to stream the entire content.

### Feature Coded Data

A PC may have different characteristics which may be used to describe the PC in an implicit representation. Such characteristics are often shared within the PC among different parts of the geometry and/or attributes of the PC. Such characteristics may also be called features. The features of a PC may be analyzed. The analysis may be used to determine an implicit representation of the PC which may further be compressed using learning-based methodologies.

For the '144 application, the feature extractor/aggregator uses finer (child) levels of detail as its input. Because the finer level of voxels (always) have more detailed information compared to voxels from a parent level, more representative features may be extracted more easily. In the context of PCs, a feature is a vector entity which describes the characteristics of a 3D voxel. A feature map is multi-dimensional array containing collection of features for all voxels. A geometric feature map is a 3D tensor that carries the characteristic information about the 3D geometry of the PC. The resolution of the geometric feature map is the 3D resolution of the octree at a hierarchical level. The resolution of the geometric feature map at every hierarchical level may be deduced based on the hierarchical level index and the original resolution of the input PC.

All feature vector elements at a particular index within a feature map may also be a feature channel. For example, if a feature map has a resolution of 3×3×4 with a feature vector length of 4, then there are four feature channels for each feature channel of resolution 3×3. The generated feature map at each hierarchical level is arithmetically encoded. Information related to the probability distribution of features in the feature map may either be generated by a previously decoded feature at the previous hierarchical level or by inputting some data to the arithmetic encoder while performing feature coding. In addition to generating the bitstream, the feature encoder also outputs the reconstructed feature, which may not be exactly the same as the feature from the analysis. The reconstructed feature should match the decoded features of a decoder.

### Octree Occupancy Coded Data

The '144 application discusses analyzing the features from the PC and further aggregating and/or refining them by a few convolutional layers. After that, the output is passed to a Multi-Layer Perceptron (MLP) to finally compute the probability. The occupancy probability estimator (OPE) uses a neural network model. The OPE takes the reconstructed feature as its input and determines/computes the occupancy probability of a current octree voxel. The octree coded data corresponds to the occupancy probability of a certain octree representing the PC.

### Hyperprior Data

The '144 application introduces a hyperprior. The purpose of the hyperprior is to analyze and utilize the distribution of a feature to perform efficient arithmetic coding of the feature. The feature is sent to a hyperprior analysis block to aggregate a hyperprior feature that is more abstract than the input feature. The hyperprior feature is much easier to encode. At the decoder, the encoded hyperprior feature is decoded and is used to compute the hyperprior parameters, which are later used to decode the feature.

The hyperprior features are encoded into a hyperprior bitstream. The hyperprior bitstream may undergo some quantization and arithmetic encoding. The hyperprior bitstream is arithmetically decoded and dequantized to output a reconstructed hyperprior feature.

The hyperprior encoder is more advanced than the feature encoder and may provide higher coding performance. The “hyperprior analysis” and “hyperprior synthesis” blocks are typically learnable neural network blocks for some embodiments.

### Typical Geometry Coding Framework

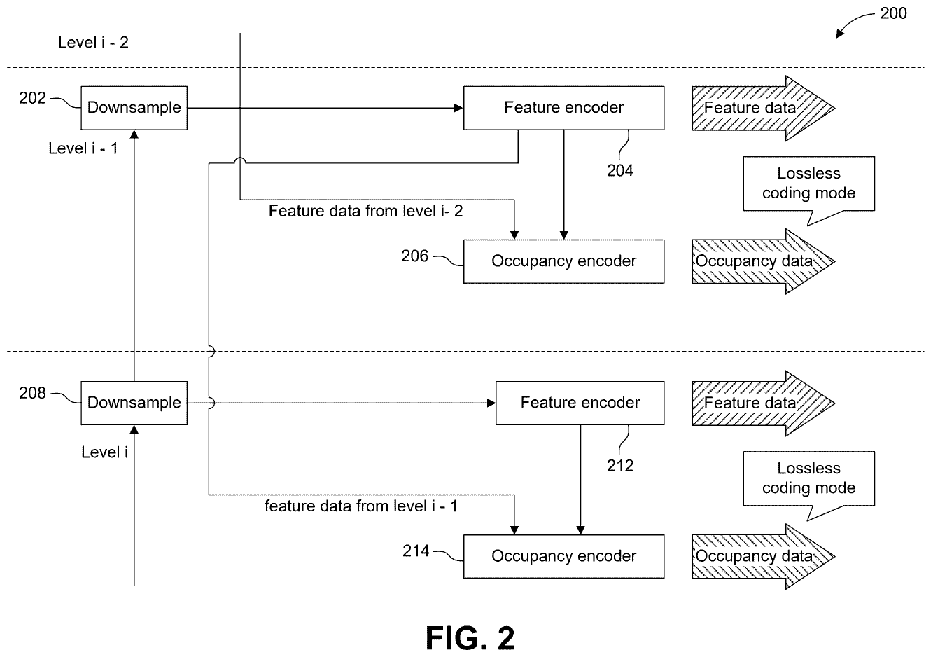

FIG. 2 is a process diagram illustrating an example coding framework with implicit hyperprior synthesis according to some embodiments. For some embodiments, the framework and interface between blocks in the codecs may differ for the '144 application.

In some cases, at a current hierarchical level, a feature map is encoded with some prior from the decoded feature data from the previous hierarchical level. At the current hierarchical level, the feature map is decoded to estimate the probability of occupancy of the current octree voxel. The probability of octree occupancy is arithmetically coded with the reconstructed feature information for each voxel at the resolution of the current hierarchical level. This coding framework 200 is shown in FIG. 2.

For some embodiments, data for a level i is downsampled 208 and passed through a feature encoder 212 to generate feature data. An output of a feature encoder 212 is passed to an occupancy encoder 214. Data for a level i−1 is downsampled 202 and passed through a feature encoder 204 to generate feature data. An output of the feature encoder 204 is passed to an occupancy encoder 206. Each of the occupancy encoders 206, 214 also uses an output of a feature encoder one level up. For some embodiments, the feature encoder 212 includes a feature aggregator. A feature aggregator is used for all levels, not just level i.

The octree occupancy data provides a lossless decoding and reconstruction of the PC. The feature data is decoded and reconstructed to generate a lossy reconstruction of the PC.

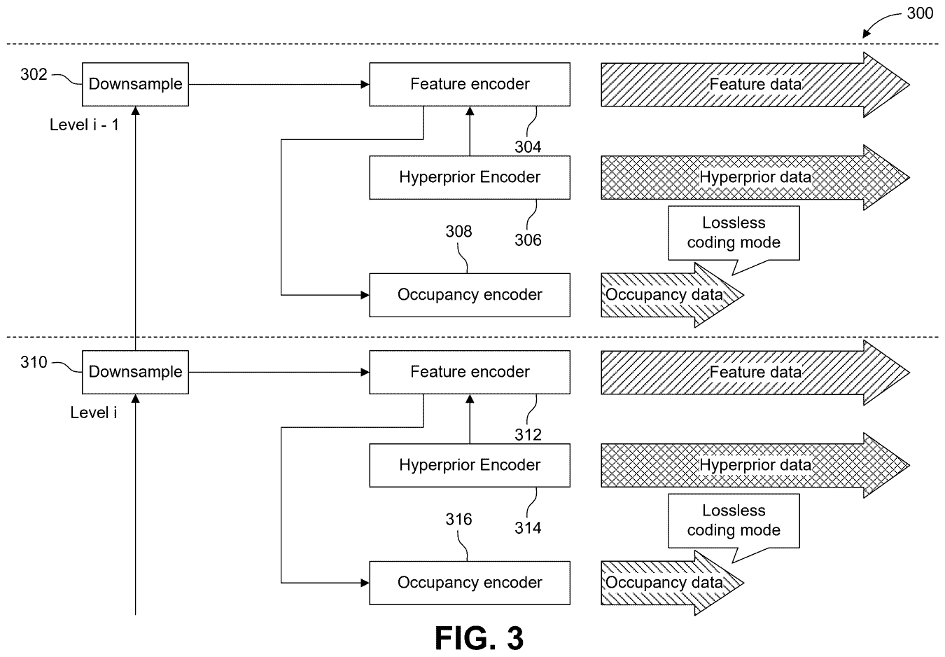

FIG. 3 is a process diagram illustrating an example coding framework with explicit hyperprior data according to some embodiments. In some embodiments of an architecture 300, in addition to the previous architecture of FIG. 2, at a current hierarchical level prior to feature encoding, the distribution parameters, also called hyperprior parameters, of the feature are generated. The hyperprior parameters includes variance parameters of the feature. The hyperprior parameters also includes both the mean and the variance parameters of the feature. The estimated hyperprior parameters (mean and variance) are provided to an arithmetic encoder to encode the feature at the current level. The hyperprior data is signaled by the encoder 314, 306 to the feature encoder 312, 304 to reduce the complexity of the decoder by removing the need for reconstructing the hyperprior from the previous decoded feature at the previous hierarchical level. Therefore, this methodology may result in a simplified decoder design for some embodiments. The hyperprior data is coded with the same resolution as the feature map.

For some embodiments, data for a level i is downsampled 310 and passed through a feature encoder 312 to generate feature data. An output of a feature encoder 312 is passed to an occupancy encoder 316. Data for a level i−1 is downsampled 302 and passed through a feature encoder 304 to generate feature data. An output of the feature encoder 304 is passed to an occupancy encoder 308.

As discussed with regard to FIG. 2, the octree occupancy data enables a lossless decoding and reconstruction of the PC. The feature data along with the hyperprior data is decoded and reconstructed to generate a lossy reconstruction of the PC.

### Typical Attribute Coding Framework

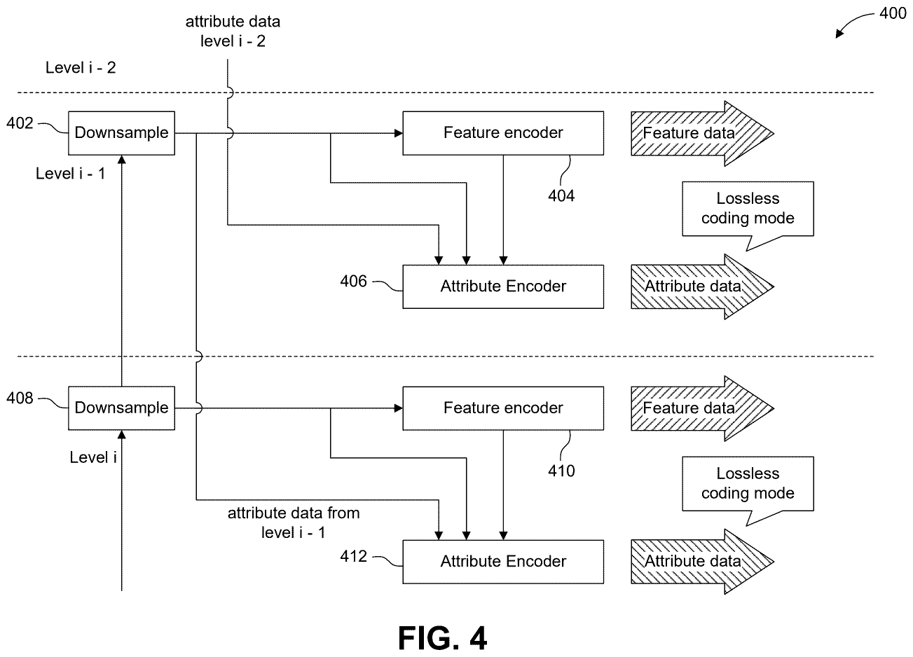

FIG. 4 is a process diagram illustrating an example attribute encoding framework according to some embodiments. For the '144 application, a typical attribute coding framework uses a learning-based method to code the attribute information of the point cloud. As shown in FIG. 4, attributes of the PC may be coded using a similar coding framework 400 as used for coding the geometry. Geometry coding and attribute coding may differ in two ways. An attribute coding framework relies on the decoded geometry data to encode the attribute information. In place of an occupancy estimator, a distribution parameter estimator block is used to determine the distribution probability of the attribute elements in a slice.

For some embodiments, data for a level i is downsampled 408 and passed through a feature encoder 410 to generate feature data. An output of a feature encoder 410 is passed to an attribute encoder 412. The attribute encoder 412 also receives as an input the input to the feature encoder 410 and the input to the feature encoder 404 for the i−1 level.

For some embodiments, data for a level i−1 is downsampled 402 and passed through a feature encoder 404 to generate feature data. An output of a feature encoder 404 is passed to an attribute encoder 406. The attribute encoder 406 also receives as an input the input to the feature encoder 404 and the input to the feature encoder for the i−2 level.

Data for a level i−1 is downsampled 302 and passed through a feature encoder 304 to generate feature data. An output of the feature encoder 304 is passed to an occupancy encoder 308.

### TLV Bytestream Format

One of the Bytestream formats is a Type-Length-Value (TLV) encapsulated Bytestream format. The TLV format delivers data as an ordered stream of bytes. Each TLV unit defines a type for each TLV unit. Such bitstream format is used in specifications such as Information Technology—Coded Representation of Immersive Media Part 9: Geometry-Based Point Cloud Compression, ISO/IEC, ISO/IEC 23090-9:2023 (2023), available at: iso<dot>org/standard/78990<dot>html (“ISO/IEC 23090-9:2023”).

AS shown in Table 1, the variable tlv_type identifies the syntax structure represented by the tlv_payload_bytes. The variable tlv_num_payload_bytes specifies the length in bytes of the syntax element array tlv_payload_byte. The array tlv_payload_byte[i] is the i-byte of payload data.

TABLE 1

| | Descriptor |
|---|---|
| Code | |
| tlv_encapsulation( ) { | |
| tlv_type | u(8) |
| tlv_num_payload_bytes | u(32) |
| for (i = 0; i < tlv_num_payload_bytes; i++) | |
| tlv_payload_byte[i] | u(8) |
| } | |

### Access Unit

An access unit is a media data pertaining to a particular composition time in a media stream.

### Raw Byte Sequence Payload

A raw byte sequence payload or RBSP is a syntax structure containing an integer number of bytes (that is either empty or has the form of a string of data bits containing syntax elements followed by a bit equal to 1 and zero or more subsequent bits equal to 0).

### Problem to be Solved

A high-level architectural design is essential for a bitstream carrying learning-based data for point cloud content. The functional architecture of the bitstream must exhibit the ability to package the learning-based coded data with a logical structure.

### Overview

This application describes a high-level structure for a point cloud data bitstream coded using AI-based and/or learning-based methods. The bitstream stores coded information of a point cloud compressed using learning-based methods. Bitstream tools, such as slice, super slice, and parameter sets, are introduced. Such tools provide functionalities to support features, such as parallel decoding and decoding configuration.

The concept of a slice is introduced in this application. A slice contains data for different types of information for a spatial region of point cloud content. Additional parameters are introduced to facilitate the decoding of the slice data. This application discusses: a slice syntax structure; parameter sets describing the key parameters of the bitstream at sequence-level and frame-level; and a bitstream structure combining the slices and parameter sets.

### Slice Data Structure for Point Cloud

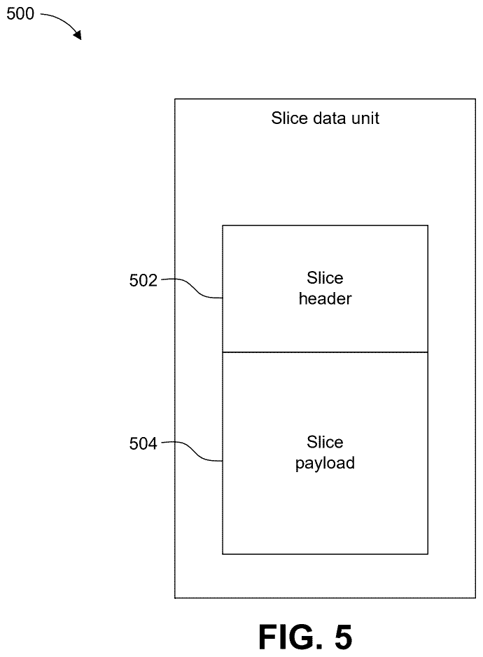

FIG. 5 is a message structure diagram illustrating an example slice data unit according to some embodiments. A slice stores data for a spatial region of the content. A slice is an independent coding unit of content coded using learning-based methods. A slice may be identified with a unique identifier (a slice ID). A slice corresponds to a spatial segmentation region of the point cloud content. The segmentation boundary may be signaled for the slice.

A group of slices may be grouped with a higher-level syntax structure, such as tiles. A set of slices contained by a tile boundary may be grouped. Additionally in some embodiments, slices may be associated with tiles without being contained in the tile boundary.

A slice provides data for a spatial region of the content that the content represents. Slice data may indicate the type of data carried within the slice. A slice may indicate the bit-depth of the coded point-cloud. The data within the slice may be quantized. The quantization factor of the coded data is learned by the neural network. Therefore, while decoding the quantization factor of the coded data is determined by the neural network model.

A slice_data_unit_rbsp( ) syntax structure is signaled by the encoder. Within the slice_data_unit_rbsp( ) syntax structure, information related to a particular slice is stored. The slice_data_unit_rbsp( ) syntax structure has two entities slice_header( ) and slice_payload( ) The slice_header( ) provides metadata and/or configuration information related to the coded slice in the payload. The slice_payload( ) includes the actual coded slide data. A slice_data_unit_rbsp( ) is defined as an RBSP syntax structure because using the RBSP syntax structure ensures strict bytes boundaries.

A slice data unit 500 may describe either the geometry data or the attribute data. Two different slice data unit structures namely slice_geometry_data_unit and slice_attribute_data_unit are described. A slice_geometry_data_unit syntax structure signals coded geometry data of the point cloud. A slice_attribute_data_unit syntax structure signals coded attribute data of the point cloud. For some embodiments, a slice data unit 500 may include a slice header field 502 and a slice payload field 504.

### Geometry Slice Data Structure

Table 2 shows an example syntax for a function slice_geometry_data_unit_rbsp( ) A slice_geometry_data_unit_rbsp( ) syntax structure carries a slice_geometry_header( ) syntax structure. The slice_geometry_header( ) syntax structure signals metadata which is required to decode the coded slice geometry payload in the slice_geometry_payload( ) syntax structure.

TABLE 2

Descriptor

```
Code
slice_geometry_data_unit_rbsp( ) {
  slice_geometry_header( )
  slice_geometry_payload( )
}
```

### Geometry Slice Header

Table 3 shows an example code listing for a slice_geometry_header( ) function, which carries information required for decoding the slice geometry payload. The information is carried in the forms of syntax elements described in the slice_geometry_header( ) Concerning GEOMETRY_DIM mentioned in Table 3, a variable may be initialized based on some higher level information in the bitstream. For instance, the geometry dimension may be set at the sequence level by the SPS or at the frame level by the FPS.

TABLE 3

| | Descriptor |
|---|---|
| Code | |
| slice_geometry_header( ) { | |
| sgh_geo_id | u(v) |
| sgh_geo_label | u(v) |
| sgh_geo_type | ue(v) |
| sgh_frame_parameter_set_id | u(8) |
| sgh_slice_geo_bit_depth | ue(v) |
| sgh_slice_geo_depth_minus1 | u(8) |
| for (depthIdx=0; depthIdx<sgh_slice_depth_minus1+1; | |
| depthIdx++) { | |
| sgh_number_of_feature_dimension_minus1[depthIdx] | ue(v) |
| sgh_number_of_feature_channels_minus1[depthIdx] | ue(v) |
| } | |
| sgh_slice_geometry_dimension_minus1/ GEOMETRY_DIM | u(2) |
| for (dim=0; dim<sgh_slice_geometry_dimenson_minus1+1; | dim < |
| dim++) { | GEOMETRY_DIM |
| sgh_slice_geo_bottom_left[dim] | ue(v) |
| sgh_slice_geo_top_right[dim] | ue(v) |
| } | |
| sgh_geo_lossless_depth_index / | u(8) |
| sgh_geo_occupancy_coding_depth_index | |
| sgh_geo_lossy_depth_index / | u(8) |
| sgh_geo_feature_coding_depth_index | |
| sgh_geo_extension_present_flag | u(1) |
| if (sgh_extension_present_flag) { | |
| sgh_geo_extension_8_bits_flag | u(8) |
| } | |
| if (sgh_extension_8_bits_flag) { | |
| while (more_rbsp_data( )) { | |
| sgh_data | u(1) |
| } | |
| } | |
| } | |

sgh_geo_id specifies the identifier for the geometry slice. The geometry slice identifier is used to reference a geometry slice. A syntax element for a slice may label the slice to some higher-level concept, such as a tile. If tile information is present, the slice may identify a tile to which the slice belongs. Thereby, the sgh_geo_label syntax element may signal the value of the tile identifier to which the slice belongs. A syntax element or a set of syntax elements is/are signal which specifies the slice position in the 3D space relative to the point cloud.

sgh_geo_type identifies the type of the data carried in the slice. For some embodiments, the type of slice data may be restricted to either being intra-coded slices or inter-coded slice.

Each slice signals a value that identifies which frame parameter set is applicable to the slice. A frame parameter set carries information which may be shared by multiple slices within each frame or shared by slices over multiple frames. A syntax element, such as sgh_frame_parameter_set_id, indicates the identifier for the frame parameter set that is applicable or that may be activated during the decoding process to decode the payload carried in the slice data unit.

An sgh_slice_geo_bit_depth syntax element indicates the bit depth of the coded slice geometry data carried in the slice payload. A syntax element, such as sgh_slice_depth_minus1, indicates the depth of the hierarchical tree. The slice payload carries coded data for the entire depth of the slice. A syntax element, such as sgh_slice_geometry_dimension_minus1, indicates the dimension of the slice geometry. Typically, the slice geometry is 3D data. However, there may be point cloud data that is 1D or 2D. The information carried in the sgh_slice_geo_bit_depth, sgh_slice_geo_depth_minus1, and sgh_slice_geo_dimension_minus1 syntax elements may remain consistent or may be shared across multiple slices in a frame(s). In such case, some syntax elements in the frame parameter set may indicate the slice geometry bit depth, slice geometry depth, and slice geometry dimension information.

An encoder encoding a slice using learning-based methods such as feature aggregation may signal the total number of feature dimension and total number of feature channels for the slice. This information is useful for decoding the arithmetic coded representation of feature data. The number of feature dimensions and number of feature channels may remain consistent across multiple slices. In such cases, the encoder may signal the information of the number of feature dimension and number of feature channels in the frame parameter set, as this avoids replicating the shared information about features in different slices. As indicated earlier, each slice indicates an index to a frame parameter set which shall be activated for decoding the slice.

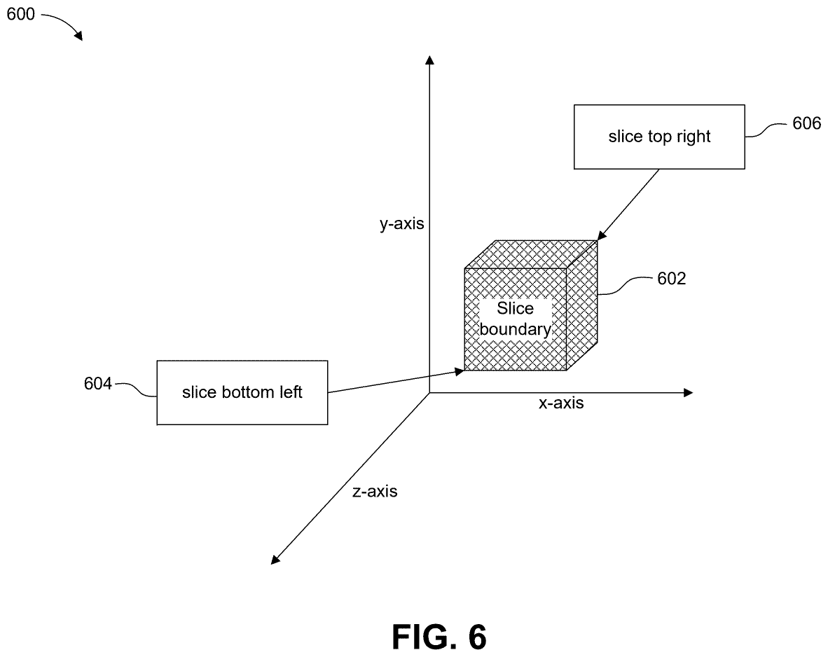

FIG. 6 is a schematic perspective view illustrating an example slice boundary according to some embodiments. A slice boundary is specified with some syntax elements, such as sgh_slice_geo_bottom_left and sgh_slice_geo_top_right. These syntax elements are specified for each dimension with the number of dimensions signaled in slice_geometry_dimension_minus1. The sgh_slice_geo_bottom_left syntax element indicates the bottom left corner 604 of the slice boundary 602 and the sgh_slice_geometry_top_right syntax element indicates the top right corner 606 of the slice boundary 602. With slice geometry boundary corner information, the complete multi-dimensional slice boundary may be determined. For example, in FIG. 6, the slice boundary of the 3D dimensional slice may be determined by the syntax elements indicating 3D information about the top right and bottom left corner of the 3D slice in a 3D coordinate system 600.

The encoder/decoder may also signal/decode some information that describes the depth level until which the slice geometry is losslessly coded. In other words, the occupancy data along with feature and/or hyperprior data of a geometry slice exists up to a particular depth level. This information may be indicated by a depth level index, such as sgh_geo_lossless_depth_level_index or sgh_geo_occupancy_coding_depth_index.

Similarly, the encoder may signal some information that describes the depth level beyond which the slice geometry is coded with loss. In other words, only feature coded data is available beyond a particular depth level index. This information may be indicated by a depth level index such as sgh_geo_lossy_depth_level_index or sgh_geo_feature_coding_depth_index. The value indicated by sgh_geo_lossless_depth_level_index or sgh_geo_occupancy_coding_depth_index is less than or equal to the value indicated by sgh_geo_lossy_depth_level_index or sgh_geo_feature_coding_depth_index. In the slice header, some information bytes are reserved for future extension.

### Geometry Slice Payload

Some examples of a slice geometry payload include: (1) slice geometry payload with no hyperprior data; (2) slice geometry payload with explicit hyperprior data; (3) slice geometry payload with only octree occupancy data for lossless coding; and (4) slice geometry payload on a per-depth level basis.

Tables 4 to 7 show some examples of a slice geometry payload.

### First Method

In some embodiments, the slice payload carries a coded representation of features for each depth level of a particular slice. The coded feature data from the feature encoder are coded using an arithmetic encoder. The learning-based encoder signals coded feature data for each depth level of a slice. When lossless coding of the geometry is enabled, the encoder signals octree occupancy information coded using an arithmetic coding engine. The octree occupancy data may be signaled up to a particular depth level.

As shown in FIGS. 2 and 3, the learning-based codec decodes the feature data for a particular level. For a current depth level, the previously decoded feature data from depth level one less than the current depth level is used to synthesize the hyperprior data. To facilitate the decoding of the feature data, the feature dimensions and number of feature channels are used as a parameter to determine the number of bins required for the arithmetic decoding. The synthesized hyperprior data provides the relevant context information to the arithmetic decoder to decode the feature data. The decoded feature data are then used to provide context to the arithmetic decoding of the octree occupancy data.

The end of the coded slice payload is determined by the syntax element end_of_slice_one_bit and the value of the syntax element shall be 1. The number of bins required to decode the end_of_slice_one_bit syntax element is one. The syntax element indicates that arithmetic decoding shall be terminated for the current slice. Table 4 shows an implementation of slice_geometry_payload( ) for some embodiments. For some embodiments, the hyperprior data is generated at the base layer. For some embodiments, the decoded feature from the last level is used for the current level to generate the hyperprior data or to provide distribution parameters. This generated or provided data is used to decode a feature at the current level. For some embodiments, the octree_occupancy_data[ ] may be in the range of 0 to (2\hat{ }24)−1.

TABLE 4

| | Descriptor |
|---|---|
| Code | |
| slice_geometry_payload( ) { | |
| for (depthIdx=0; depthIdx<slice_depth_minus1; | |
| depthIdx++) { | |
| feature_geometry_data[depthIdx] | ae(v) |
| if (sps_lossless_coding_enabled && depthIdx < | |
| lossless_depth_index) { | |
| octree_occupancy_data[depthIdx] | ae(v) |
| } | |
| } | |
| end_of_slice_one_bit | ae(v) |
| } | |

### Second Method

In some embodiments, the encoder signals the hyperprior required for the current depth level to be used for decoding of the feature data and subsequently the octree occupancy data. This design shifts the complexity of the synthesis of the hyperprior for a current level by encoding the hyperprior data within the bitstream. This reduces the decoder complexity. However, the bit rate increases due to the bitstream carrying additional information. A learning-based encoder employs a hyperprior encoder and feature encoder to encode the PC with lossless configuration. Thereby, the slice payload also includes hyperprior data and feature data for the lossless coded slice along with the octree data for the slice at a depth level. Table 5 shows an implementation of slice_geometry_payload( ) for some embodiments.

TABLE 5

| | Descriptor |
|---|---|
| Code | |
| slice_geometry_payload( ) { | |
| for (depthIdx=0; depthIdx<slice_depth_minus1; | |
| depthIdx++) { | |
| hyperprior_data[depthIdx] | ae(v) |
| feature_data[depthIdx] | ae(v) |
| if (sps_lossless_coding_enabled && depthIdx < | |
| sgh_geo_occupancy_coding_depth_index) { | |
| octree_occupancy_data[depthIdx] | ae(v) |
| } | |
| } | |
| end_of_slice_one_bit | ae(v) |
| } | |

### Third Method

In some embodiments, a slice payload carries coded data for a particular slice with different depth levels. For depth levels below a certain depth level index signaled by a syntax element such as sgh_lossless_depth_level_index, the data carried in the slice is coded octree data which corresponds to lossless coding of the PC for coarse levels of PC representation. For depth levels above a certain index signaled by a syntax element such sgh_lossy_depth_level_index, the data carried in the slice is coded hyperprior data and feature data which corresponds to lossy coding of the PC for finer level of PC representation. This design may incur a significant increase in the bitstream as the decoding of the octree occupancy data is not facilitated by any feature or hyperprior data. Thereby, occupancy data is self-contained data i.e. for decoding the octree occupancy no additional context information is required. Table 6 shows an implementation of slice_geometry_payload( ) for some embodiments.

TABLE 6

| | Descriptor |
|---|---|
| Code | |
| slice_geometry_payload( ) { | |
| for (depthIdx=0; depthIdx<slice_depth_minus1; | |
| depthIdx++) { | |
| if (sps_lossless_coding_enabled && depthIdx < | |
| sgh_geo_occupancy_coding_depth_index) { | |
| octree_occupancy_data[depthIdx] | ae(v) |
| } | |
| if (sps_lossy_coding_enabled && depthIdx >= | |
| sgh_geo_feature_coding_depth_index) { | |
| hyperprior_data[depthIdx] | ae(v) |
| feature_data[depthIdx] | ae(v) |
| } | |
| } | |
| end_of_slice_one_bit | ae(v) |
| } | |

### Fourth Method

In some embodiments, the payload for a slice is split on a per depth level basis. In other words, the payload carried in the slice data unit is split into independent sub-slices. The per-depth level payload complements the design shown in FIG. 3. Each individual hierarchical level is decoded based on the occupancy data from the previous hierarchical level. This design may allow the application to request and download only until a certain depth level of the data. Table 7 shows an implementation of slice_depth_geom_payload( ) for some embodiments.

TABLE 7

| | Descriptor |
|---|---|
| Code | |
| slice_depth_geom_payload(depthIdx) { | |
| hyperprior_data[depthIdx] | ae(v) |
| feature_data[depthIdx] | ae(v) |
| if (sps_lossless_coding_enabled && depthIdx < | |
| sgh_geo_occupancy_coding_depth_index) { | |
| octree_occupancy_data[depthIdx] | ae(v) |
| } | |
| end_of_slice_one_bit | ae(v) |
| } | |

In such cases, the slice header may carry information related to only one depth level since only one depth level is carried in payload. The slice header shall have a bitstream conformance condition to ensure that there is only one instance of a depth level index for a slice.

### Attribute Slice Data Structure

Attributes are coded like geometry data of the PC as described regarding FIG. 4. The attribute slice data structure shown in this section is similar to the coded attribute design of the geometry slice data structure shown above. Table 8 shows an example structure of the function slice_attribute_data_unit_rbsp( ).

TABLE 8

| | |
|---|---|
| Code | Descriptor |

```
slice_attribute_data_unit_rbsp( ) {
  slice_attribute_header( )
  slice_attribute_payload( )
}
```

### Attribute Slice Header

Table 9 shows an example of a slice_attribute_header( ) carrying information required for decoding the slice attribute payload. The information is carried in the forms of syntax elements described in the slice_attribute_header( ).

TABLE 9

| Code | Descriptor |
|---|---|
| slice_attribute_header( ) { | |
| sah_attr_geo_id | u(v) |
| sah_attr_slice_type | ue(v) |
| sah_attr_slice_id | ue(v) |
| sah_attribute_id | ue(v) |
| sah_attr_slice_depth_minus1 | u(8) |
| sah_attr_lossless_depth_index | u(8) |
| sah_attr_lossy_depth_index / | u(8) |
| sah_attr_feature_coding_depth_index | |
| for (depthIdx=0; depthIdx<sah_slice_depth_minus1+1; | |
| depthIdx++) { | |
| sah_attr_number_of_feature_dimension_minus1[depthIdx] | ue(v) |
| sah_attr_number_of_feature_channels_minus1[depthIdx] | ue(v) |
| } | |
| sah_attr_dimension_minus1/ Attribute_DIM | u(2) |
| for (dim=0; dim<sah_attr_dimenson_minus1+1; dim++) | dim < |
| { | ATTRIBUTE_DIM |
| sah_attr_slice _bottom_left[dim] | ue(v) |
| sah_attr_slice_top_right[dim] | ue(v) |
| } | |
| sah_attr_extension_present_flag | u(1) |
| if (sah_attr_extension_present_flag) { | |
| sah_attr_extension_8_bits_flag | u(8) |
| } | |
| if (sah_attr_extension_8_bits_flag){ | |
| while(more_rbsp_data( )) { | |
| sah_attr_data | u(1) |
| } | |
| } | |
| } | |

sah_attr_geo_id identifies the identifier for the geometry slice which serves as a reference geometry slice for the attribute information carried in the slice attribute data structure.

sah_attr_slice_type identifies the type of the data carried in the slice. The type of slice data may be restricted to either being intra-coded slices or inter-coded slice.

sah_attr_slice_id specifies the identifier for attribute slice. This attribute slice ID may be used for reference purposes.

sah_attribute_id indicates the unique identifier of the attribute type carried in the attribute slice. The identifier is used to indicate the decoder to find the corresponding information about the attribute data in some high-level function. For example, the unique identifier value in sah_attribute_id indicates the attribute unique id ai_attribute_type_id shown in Table 15. AttributeInformation( ) syntax function carried metadata regarding the attribute carried within the bitstream. The term “ai” that begins several variable names stands for “attribute information.”

A syntax element for example sah_attr_slice_depth_minus1 indicates the depth of the hierarchical tree of the slice attribute. The slice attribute payload carries coded data for the entire depth of the slice's attribute data. A syntax element for example sah_attr_dimension_minus1+1 indicates the dimension of the slice attribute. In some cases, the dimension of slice attribute may be determined by some high-level function such as attribute_information( ) in syntax element ai_dimensions_minus1. Thereby, Attribute_DIM may be equated to the value in ai_dimension_minus1 for a slice in which sah_attribute_id matches the value indicated in ai_attribute_unique_id in the attribute_information( ) syntax function.

An encoder encoding a slice using learning-based methods such as feature aggregation may signal the total number of feature dimension and total number of feature channels for the attribute coded in the slice. This information serves useful to decode the arithmetic coded representation of feature data. The number of feature dimension and number of feature channel may remain consistent across multiple slices. In such cases, the encoder may signal the information on number of feature dimension and number of feature channels in frame parameter set since this reduces replicating the shared information about features for different slices. Each attribute slice refers to a geometry slice in the slice attribute header, and each geometry slice refers to a frame parameter set in the slice geometry header. Therefore, a correspondence between the slice attribute and a frame parameter set may be established. The frame parameter set of the indicated frame parameter set ID may be activated for decoding of the attribute slice data.

An attribute slice boundary is specified with some syntax elements such as sah_attr_slice_bottom_left and sah_attr_slice_top_right. These syntax elements are specified for each dimension with number of dimensions signaled either in the attribute slice header in sah_attr_dimension_minus1 or ai_attribute_dimension_minus1 in attribute_information( ) syntax function in the sequence parameter set. sah_attr_bottom_left indicates the bottom left corner of the attribute slice boundary. sah_attr_top_right indicates the top right corner of the attribute slice boundary. With attribute slice boundary corner information, the complete multi-dimensional slice boundary may be determined. The slice boundary for a geometry slice and attribute slice may be different as typically attribute data is a multi-dimensional and data in each dimension may lie in range of values usually described by the bit depth e.g. indicated by ai_bit_depth in attribute_informatio( ) of the attribute. Therefore, in some cases it may serve helpful to define separate slice boundaries for geometry and attribute slice.

Some bytes of the information are reserved in the slice attribute header for future extension.

### Attribute Slice Payload

Some examples of slice attribute payload include: (1) slice attribute payload with no hyperprior data; (2) slice attribute payload with explicit hyperprior data; and (3) slice geometry payload with only octree occupancy data for lossless coding.

### First Method

In one embodiment, the slice payload carries coded representation of feature for each depth level of a particular slice. The coded feature data from feature encoder is coded using arithmetic encoder. The learning-based encoder signal coded feature data for each depth level of an attribute slice. In case lossless coding of the geometry is enabled then the encoder shall signal distribution parameter information coded using an arithmetic engine. The distribution parameter data may be signaled until a particular depth level.

As illustrated in FIG. 4 and described regarding Table 4, the learning-based codec decodes the feature data for a particular level. For a current depth level, the previously decoded feature data from depth level one less than the current depth level is used to synthesis the hyperprior data. To facilitate the decoding of the feature data, the feature dimension and the number of feature channels are used as parameters to determine the number of bins required for arithmetic decoding. The synthesized hyperprior data provides relevant context information to the arithmetic decoder to decode the feature data. The decoded feature data is then further used to provide context to the arithmetic decoding of the distribution parameter data.

The end of the coded slice payload is determined by the syntax element end_of_slice_one_bit when the value of the syntax element is 1. The number of bins required to decode the end_of_slice_one_bit syntax element is one. The syntax element indicates that CABAC decoding shall be terminated for the current attribute slice.

TABLE 10

| Code | Descriptor |
|---|---|
| slice_attribute_payload( ) { | |
| for (depthIdx=0; depthIdx<slice_depth_minus1; | |
| depthIdx++) { | |
| feature_attr_data[depthIdx] | ae(v) |
| if (sps_lossless_coding_enabled && depthIdx < | |
| sah_attr_lossless_depth_index) { | |
| attribute_data[depthIdx] | ae(v) |
| } | |
| } | |
| end_of_slice_one_bit | ae(v) |
| } | |

### Second Method

In some embodiments, the encoder signals the hyper prior required for the current depth level to be used for decoding of the feature data and subsequently the distribution parameter set. As discussed regarding Table 5, this design shifts the complexity of the synthesis the hyperprior for a current level by rather encoding the hyperprior data within the bitstream. This reduces the decoder complexity. However, the bitrate increases due to the bitstream carrying additional information. A learning-based encoder employs a hyperprior encoder and feature encoder to encode the PC with lossless configuration. Thereby, the attribute slice payload also includes hyper prior data and feature data for the lossless coded slice along with the distribution parameter data for the attribute slice at a depth level.

TABLE 11

| Code | Descriptor |
|---|---|
| slice_attribute_payload( ) { | |
| for (depthIdx=0; depthIdx<slice_depth_minus1; | |
| depthIdx++) { | |
| hyperprior_attr_data[depthIdx] | ae(v) |
| feature_attr_data[depthIdx] | ae(v) |
| if (sps_lossless_coding_enabled && depthIdx < | |
| sah_attr_lossless_depth_index) { | |
| attribute_data[depthIdx] | ae(v) |
| } | |
| } | |
| end_of_slice_one_bit | ae(v) |
| } | |

### Third Method

In some embodiments, a slice payload carries coded data for a particular slice with different depth levels. For depth levels below a certain depth level index signaled by a syntax element such as sah_attr_lossless_depth_level_index, the data carried in the slice is coded attribute data which corresponds to lossless coding of the PC for coarse levels of PC representation. For depth levels above a certain index signaled by a syntax element such sah_attr_feature_coding_depth_level_index, the data carried in the slice is coded hyperprior data and feature data which corresponds to lossy coding of the attribute of PC. This design may incur a significant increase in the bitstream as the decoding of the attribute data is not facilitated by any feature or hyperprior data. On the other hand, attribute data is self-contained data. To decode the attribute data, no additional context information is required.

TABLE 12

| Code | Descriptor |
|---|---|
| slice_attribute_payload( ) { | |
| for (depthIdx=0; depthIdx<slice_depth_minus1; | |
| depthIdx++) { | |
| if (sps_lossless_coding_enabled && depthIdx < | |
| sah_attr_lossless_coding_depth_index) { | |
| attribute_data[depthIdx] | ae(v) |
| } | |
| if (sps_lossy_coding_enabled && depthIdx >= | |
| sah_attr_feature_coding_depth_index) { | |
| hyperprior_attr_data[depthIdx] | ae(v) |
| feature_attr_data[depthIdx] | ae(v) |
| } | |
| } | |
| end_of_slice_one_bit | ae(v) |
| } | |

### Parameter Set

For some embodiments, parameter sets are essential information which may be used to initialize the decoder with the necessary parameters to decode the bitstream. Also, separating the parameters from the coded data allows the function to transmit the parameter set and the coded data independently.

### Sequence Parameter Set

A syntax structure, for example Sequence Parameter Set, is a structure which contains information that applies to a sequence of coded point cloud frames. For some embodiments, a sequence-level syntax structure is essential to initialize the decoder to decode the coded point cloud frames. The term “sps” that begins several variable names stands for “sequence parameter set.”

TABLE 13

| Code | Descriptor |
|---|---|
| sequence_parameter_set( ) { | |
| profile( ) | |
| sps_sequence_parameter_set_id | u(8) |
| sps_lossless_coding_enabled | u(1) |
| sps_lossy_coding_enabled | u(1) |
| sps_attribute_present_flag | u(1) |
| if (sps_lossless_coding_enabled) { | |
| sps_lossless_lambda_geometry | ui(32) |
| } | |
| if (sps_lossy_coding_enabled) { | |
| sps_feature_coding_geometry_flag | u(1) |
| sps_lossy_lambda_geometry | ue(v) |
| sps_voxel_feature_coding_flag | u(1) |
| } | |
| sps_skip_last_level_geometry_flag | u(1) |
| sps_persistent_motion_per_slice_flag | u(1) |
| sps_share_weight_flag | u(1) |
| sps_geometry_feature_coding_depth_index | u(8) |
| bit_depth_minus1_of_the_decoded_geometry | u(8) |
| sps_geometry_dimension_minus1 | u(2) |
| GEOMETRY_DIM = sps_geometry_dimension_minus1 + 1 | |
| if (sps_attribute_present_flag) { | |
| attributes_information( ) | |
| sps_attribute_coding_mode | u(4) |
| if (sps_attribute_coding_mode == ATTR_CODE_AI) { | |
| if (sps_lossless_coding_enabled) { | |
| sps_lossless_lambda_attribute | ue(v) |
| } | |
| if (sps_lossy_coding_enabled) { | |
| sps_lossy_lambda_attribute | ue(v) |
| sps_feature_coding_attribute_flag | u(1) |
| } | |
| sps_skip_last_level_attribute_flag | u(1) |
| sps_attr_feature_coding_depth_index | u(8) |
| } | |
| if (sps_attribute_coding_mode == ATTR_CODE_GPCC) { | |
| sps_attribute_parameter_set_length | u(4) |
| AttrParamSetLen = | |
| sps_attribute_parameter_set_length | |
| attribute_parameter_set_data(AttrParamSetLength) | |
| } | |
| } | |
| } | |

TABLE 14

| Code | Descriptor |
|---|---|
| attribute_parameter_set_data(numBytes) { | |
| for (i=0; i<numBytes; i++) { | |
| attr_parameter_set_data_byte[i] | u(8) |
| } | |
| } | |

A sequence parameter set (SPS) is identified by its identifier, such as sps_sequence_parameter_set_id. The SPS ID may be used by the decoder to activate a sequence parameter set among a list of sequence parameter sets. The activation of a sequence parameter set is typically determined by sending updates to the decoder to reconfigure the parameters.

The syntax element sps_lossless_coding_enabled signals whether tools for lossless coding are present in the bitstream. The syntax element sps_lossless_coding_enabled equal to 0 indicates that there are no lossless coding tools present in the bitstream. The syntax element sps_lossless_coding_enabled equal to 1 indicates that there are lossless coding tools present in the bitstream. Similarly, a syntax element sps_lossy_coding_enabled signals whether tools for lossy coding are present in the bitstream. Setting the syntax element sps_lossy_coding_enabled equal to 0 indicates that there are no lossy coding tools present in the bitstream. Setting the syntax element sps_lossy_coding_enabled equal to 1 indicates that there are lossy coding tools present in the bitstream. Typically, lossy coding tools are related to tools required in feature coding and/or hyperprior coding. One the other hand, lossless coding tools are related to tools required in coding the occupancy data for the geometry and residual attribute data for different attributes. As described regarding FIGS. 2, 3, and 4, the outputs of lossy tools are used as inputs to generate/decode data to reconstruct either occupancy or attribute data losslessly.

A syntax element, e.g. sps_attribute_present_flag, is signaled by the encoder or decoded by the decoder which specifies whether coded attribute data is present in the bitstream.

A syntax element, e.g., sps_attribute_coding_mode, is signaled to determine different modes of coding for attributes. For example, setting sps_attribute_coding_mode equal to 0 may indicate attribute coding using learning-based methods. Setting sps_attribute_coding_mode equal to 1 may indicate that the attributes are coded using traditional methods, such as ISO/IEC 23090-9:2023 (G-PCC). The choice of which mode is used to code the attribute may be determined by profile as indicated in the profile( ) structure described later in this application or through some external means such as file encapsulation tools, e.g., ISOBMFF (Information Technology—Coding of Audio-Visual Objects Part 12: ISO Base Media File Format, ISO/IEC, ISO/IEC 14496-12:2022 (2022), available at: iso<dot>org/standard/83102<dot>html (“ISO/IEC 14496-12:2022”) and RTP (Schulzrinne, H., et al., RTP: A Transport Protocol for Real-Time Applications, July 2003, available at: rfc-editor<dot>org/rfc/rfc3550 (“RFC 3550”).

A syntax element e.g. sps_lossless_lambda_geometry, is signaled which determines the rate distortion factor of the lossless coded geometry of the point cloud content. The syntax element must be signaled only when the value of sps_lossless_coding_enabled is 1. Similarly, a syntax element e.g. sps_lossless_lambda_attribute is signaled which determines the rate distortion factor of the lossless coded attribute of the point cloud content. The syntax element must be signaled only when the value of sps_lossless_coding_enabled is 1 and the value of sps_attribute_present_flag is 1.

A syntax element e.g. sps_feature_coding_geometry_flag is signaled which determines whether the geometry is feature coded.

A syntax element e.g. sps_lossy_lambda_geometry, is signaled which determines the rate distortion factor of the lossy coded geometry of the point cloud content. The syntax element must be signaled only when the value of sps_lossy_coding_enabled is 1. A syntax element, e.g., sps_voxel_feature_coding_flag, is signaled to unit of coding point cloud content. Setting the syntax element sps_voxel_feature_coding_flag value equal to 0 specifies that the lossy coding of the geometry will use points as the unit for coding the content. Setting the syntax element sps_voxel_feature_coding_flag value equal to 1 specifies that the lossy coding of the geometry will use voxel as the unit for coding the point cloud content.

A syntax element e.g., sps_feature_coding_attribute_flag, is signaled to indicate whether the attribute is feature coded. A syntax element, e.g., sps_lossy_lambda_attribute, is signaled to indicate the rate distortion factor of the lossy coded attribute of the point cloud content. The syntax element must be signaled only when the value of sps_lossy_coding_enabled is 1 and the value of sps_attribute_present_flag is 1.

A syntax element e.g. sps_skip_last_level_geomety_flag is signaled which determines whether the last depth level is skipped in the coded geometry. Similarly, a syntax element e.g. sps_skip_last_level_attribute_flag is signaled which determines whether the last depth level is skipped in the coded attribute. A syntax element e.g. sps_persistent_motion_per_slice_flag is signaled which determines whether the motion in the slices is persistent across the sequence of the frames. A syntax element e.g. sps_share_weight_flag is signaled which determines whether the weights of the models will be shared in the lossy and lossless coding methods.

A syntax element, e.g., sps_attr_feature_coding_depth_index indicates the hierarchical depth index until which coded attribute residual data is signaled along with feature and/or hyperprior data.

A syntax structure, such as attribute_parameter_set_data( ) may be signaled in the bitstream. Within the syntax structure, the bitstream is a fixed amount of data that may be used to initialize the attribute decoder indicated by the profile.

### Attribute Information Syntax Structure

A point cloud content may have additional information for a point. Such information is known as attributes. Attributes may provide additional information for a point which may be used for rendering, post-decoding purposes and more. A PC coded using learning-based method may also signal a list of attributes.

A syntax structure namely, attribute_information( ) is present in the sequence parameter set. A decoder decodes the sequence parameter set to access the information signaled in the attribute_information( ) syntax function. The information signaled in the attribute_information( ) corresponds to the list of the attributes carried in the bitstream. A syntax element, e.g., ai_number_of_attributes_minus1 is present in the bitstream which may indicate the total number of attributes signaled in the bitstream.

In the list of attributes signaled in the bitstream, there may be additional information for each attribute signaled in the bitstream. The bitstream may signal a type identifier e.g. ai_attribute_type_id for the attribute which corresponds to the semantics of the data carried in the attribute. The bitstream may signal bit depth e.g. ai_bit_depth for an attribute which corresponds to the expected bit-depth of the attribute data. The bitstream may signal dimensions e.g. ai_dimensions_minus1 for an attribute in the list of attributes which corresponds to the number of components for an attribute. The number of components/dimensions of attribute may use signal attributes which are multi-dimensional. For a list of defined attribute-types the number of components and the semantics of each component of an attribute may be predefined. However, in some cases, the encoder may need to signal multi-dimensional attribute in which each component or a group of components may carry a specific information.

An attribute may be grouped in dimension group. Each dimension group may exhibit certain features of an attribute. The dimension group may be uniquely identified by an identifier such as ai_dim_group_id. For each dimension group, the attribute information corresponds to several components of an attribute. The number of components for each dimension group may be indicated by a syntax element such as ai_dim_group_number_of_component_minus1. The grouping of attribute components follows the indexing order as they are stored in the attribute. For extensibility purposes, an array of byte is reserved. The length of the byte array may be determined by a syntax element, for example, ai_reserved_bytes_length.

TABLE 15

| Code | Descriptor |
|---|---|
| attribute_information( ) { | |
| ai_number_of_attributes_minus1 | u(7) |
| NumOfAttributes = ai_number_of_attribute_minus1 + 1 | |
| for (attrIdx=0; attrIdx<NumOfAttributes; attrIdx++) | |
| { | |
| ai_attribute_unique_id[attridx] | u(8) |
| ai_attribute_type_id[attrIdx] | u(8) |
| ai_bit_depth[attrIdx] | u(8) |
| ai_dimensions_minus1[attrIdx] | u(8) |
| AttrDimensions = ai_dimension_minus1[attrIdx] + 1 | |
| ai_dim_information_present_flag[attrIdx] | u(1) |
| if (ai_dim_information_present_flag) { | |
| ai_dim_number_of_dimension_groups[attrIdx] | u(8) |
| AttrDimensionGroup = | |
| ai_dim_number_of_dimension_group[attridx] | |
| NoOfComponents = 0 | |
| for (dimGroupIdx=0; dimGroupIdx < | |
| AttrDimensionGroup; dimGroupIdx++) { | |
| ai_dim_group_id[attrIdx][dimGroupIdx] | ue(v) |
| ai_dim_group_number_of_components_minus1[attrIdx] | u(8) |
| NoOfComponents += | |
| ai_dim_group_number_of_components_minus1[attrIdx] + 1 | |
| } | |
| assert(NoOfComponents == AttrDimensions) | |
| } | |
| } | |
| ai_reserved_bytes_length | u(8) |
| for (idx=0; idx<ai_reserved_bytes_length; idx++) { | |
| ai_reserved_bytes[idx] | u(8) |
| } | |
| byte_alignment( ) | |
| } | |

Components are grouped with each group having an ID ai_dim_group_id. For some embodiments, the variable NoOfComponents is used to check whether the total of components carried in different groups is equal to the attribute dimension.

Alternatively, the components of the attribute may be grouped without an order. In such scenario, each component is indicated with a group_id which specifies the group that the components belong to. Each attribute dimension group indicates the number of attribute components which belong to the dimension group with dimension group ID as ai_dim_group_id. For each attribute components in the attribute dimension group, the ai_dim_group_comp_index indicates the index of the components in the attribute that is mapped to the dimension group with a dimension group ID of ai_dim_group_id.

TABLE 16

| Code | Descriptor |
|---|---|
| if (ai_dim_information_present_flag) { | |
| ai_dim_number_of_dimension_groups[attrIdx] | u(8) |
| AttrDimensionGroup = | |
| ai_dim_number_of_dimension_group[attridx] | |
| for (dimGroupIdx=0; dimGroupIdx<AttrDimensionGroup; | |
| dimGroupIdx++) { | |
| ai_dim_group_id[attrIdx][dimGroupIdx] | ue(v) |
| ai_dim_group_number_of_components_minus1[attrIdx] | u(8) |
| for (dimGroupCompIdx=0; dimGroupCompIdx < | |
| AttrDimensionGroupComp; dimGroupCompIdx++) | |
| ai_dim_group_comp_index[attrIdx][dimGroupIdx][dimGroupCompIdx] | ue(v) |
| } | |
| } | |
| } | |

### Profile

TABLE 17

| Code | Descriptor |
|---|---|
| profile( ){ | |
| profile_idc | u(8) |
| profile_level_idc | u(8) |
| } | |

A syntax structure may describe the bitstream capabilities and toolset required to decode the bitstream. A profile in a bitstream may also be used for interoperability purposes. For some embodiments, profiles may also describe the type of models to be used for encoding and decoding.

The profile syntax structure may indicate a syntax element such as profile_idc which identifies the profile of the bitstream. For example, the one of the values of profile_idc may restrict the coding mode for attribute data of the PC. For example, setting the profile_idc value equal to 0 may indicate that the attributes are coded using learning-based methodologies. Setting the profile_idc value equal to 1 may indicate that the attributes are coded using traditional methodologies such as G-PCC. There may be profiles which enable on geometry coding but not attribute coding. Thereby constraining the value of sps_attribute_present_flag to be 0 for such scenarios. There may also be profile which constrain to use only lossless coding methods to code the PC. Such profile may constrain the value of syntax elements, such as sps_lossless_coding_enabled to be 1 and sps_lossy_coding_enabled to be 0.

There may be another syntax element present in the bitstream indicate the level limits for the size of point cloud slice which may be processed. For example, level equal to 1 may indicate a certain number of point clouds which may be processed within a slice in a single time instance.

### Frame Parameter Set

A syntax structure, e.g., frame_parameter_set( ) signals parameter for decoder configuration which are applicable for a frame or multiple frames in a sequence of coded point cloud. The frame parameter set is identified via an identifier such as fps_frame_parameter_set_id. Along with that, a frame parameter set associates a sequence parameter set to indicate the sequence level information which are applicable to the frame/slices in a frame referred. Thereby a syntax element fps_sequence_parameter_set_id is signaled by the encoder to identify the sequence parameter set. The term “fps” that begins several variable names stands for “frame parameter set.”

A syntax element is signaled which identifies the slice threshold. The slice may have some motion which spans across many frames. The syntax element fps_global_motion_flag identifies the characteristics whether the motion data for the slice remains consistent across frames. A syntax element, e.g., fps_slice_bits_depth is signaled by the encoder or decoded by the decoder which indicates the bit depth of the coded slice geometry data. This signaling is present to indicate slice bit depth in slice header of slice data structure which share the same value of bit depth.

An encoder may signal, or a decoder may decode a frame parameter set syntax structure a syntax element such as fps_feature_coding_parameter_present_flag which indicates that feature coding parameters may be signaled in the frame parameter set. If fps_feature_coding_parameter_present_flag is 1, then the feature coding parameters are signaled in the frame parameter set. If fps_feature_coding_parameter_present_flag is 0, then the feature coding parameters are signaled in the slice header. The frame parameter set may contain information regarding the number of the feature channels and feature dimensions. The feature dimensions and feature channel information may be used to decode the coded feature data.

A frame parameter set extension is used in the frame parameter set. A frame parameter set may be further extension depending on value of the presence of fps_extension_present_flag and fps_extension_8_bits_flag. The frame parameter set may signal more data depending on the value of fps_extension_8_bits_flag. The actual representation of the value of fps_extension_8_bits_flag is reserved for future use.

TABLE 18

| Code | Descriptor |
|---|---|
| frame_parameter_set( ) { | |
| fps_frame_parameter_set_id | u(8) |
| fps_sequence_parameter_set_id | u(8) |
| fps_slice_threshold | u(12) |
| fps_global_motion_flag | u(1) |
| fps_slice_bits_depth | ue(v) |
| fps_feature_coding_parameter_present_flag | u(1) |
| if (sps_feature_coding_enabled && | |
| fps_feature_coding_parameter_present_flag) { | |
| fps_number_of_feature_channels_minus1 | ue(v) |
| fps_number_of_feature_dimension_minus1 | ue(v) |
| } | |
| fps_extension_present_flag | u(1) |
| if (fps_extension_present_flag) { | |
| fps_extension_8_bits_flag | u(8) |
| } | |
| if (fps_extension_8_bits_flag){ | |
| while (more_rbsp_data( )) { | |
| fps_data | u(1) |
| } | |
| } | |
| } | |

### Bitstream Structure

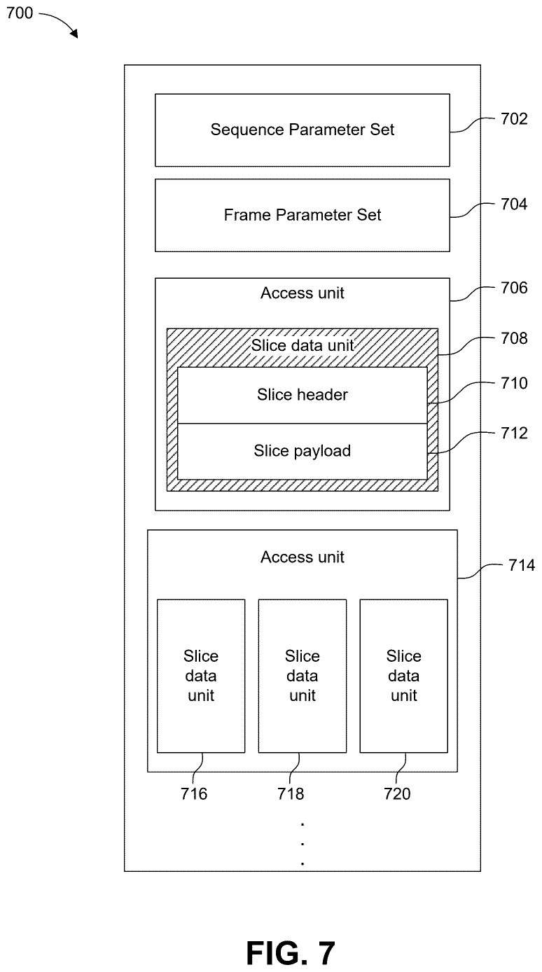

FIG. 7 is a data structure diagram illustrating an example bitstream structure according to some embodiments. A slice with learning-based point cloud coded data and the parameter set(s) 702, 704 as described regarding Table 3 may be contained in a bitstream structure. A bitstream may be composed of access units 706, 714. Each access unit 706, 714 carries the coded data for at least one slice. An access unit 714 may carry multiple slice data units 716, 718, 720, which correspond to a particular composition time.

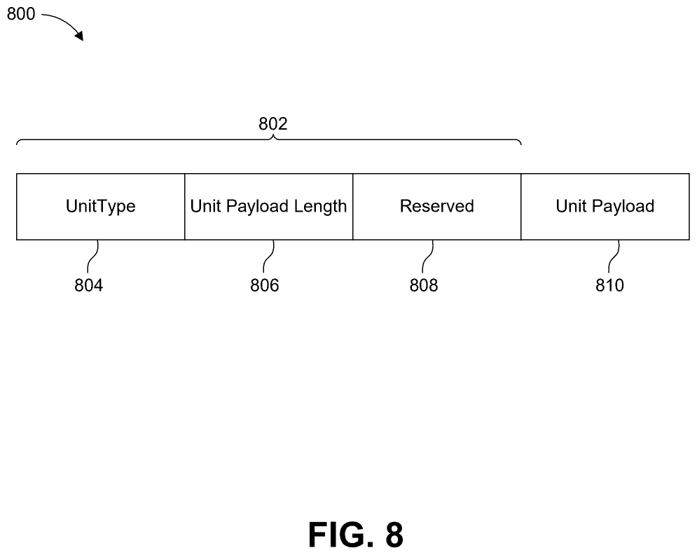

A bitstream formatted with a bitstream structure 700 and carrying learning-based data may follow encapsulation structure namely unit payload format, such as the one shown in FIG. 8. A unit payload format structure 712 may be categorized into Coded Slice Data (CSD) and Coded Non-Slice data (CNSD). A CSD carries slice data unit 708 encapsulated in a unit payload format structure. A type for different coded slice data and parameter sets 702, 704 is uniquely reserved in a unit payload type registry. The “type” information is used to identify the payload carried in the unit payload structure. The “type” information may be used by other technologies, such as ISOBMFF (ISO/IEC 14496-12:2022) containerization or RTP (RFC 3550) packet encapsulation for storage and delivery. At the same time, “types” are reserved for CNSD, such as parameter sets, among other things. For example, SPS may be identified with type: 0 in the unit header 710.

### Unit Payload Format

FIG. 8 is a message structure diagram illustrating an example unit payload format according to some embodiments. A payload format to carry configuration metadata such as parameter sets, and coded data is called a unit payload format 800. A pictorial representation of the unit payload format 800 is shown in FIG. 8. A unit payload format 800 includes a unit header 802 and a unit payload 810. Within the unit header 802, the unit type 804 and unit payload length 806 are signaled. The unit type 804 indicates an identifier to identify the type of payload carried in the unit payload. The unit payload length 806 indicates the size of the payload in bytes. Some bit fields in the unit header 802 are reserved bits 808 for future extension(s).

Tables 19-21 show an example syntax structure for a unit payload format. A list of different unit types is shown in Table 22. The unit type may signal up to 64 (2\hat{ }6) unique identifiers of payload. A syntax element, such as, unit_payload_length_minus1+1, identifies the byte length of the unit payload. In this example, two bits are reserved for future extension(s). For example, the reserved bits may be used to extend the range of values for the unit type signaling with the unit_type syntax element or to extend the range of unit payload length signaled in unit_payload_minus1 syntax element.

TABLE 19

| | |
|---|---|
| Code | Descriptor |

```
unit_payload_format( ) {
  unit_header( )
  unit_payload(ByteLengthOfPayload)
}
```

TABLE 20

| Code | Descriptor |
|---|---|
| unit_header( ) { | |
| unit_type | u(6) |
| unit_payload_length_minus1 | u(24) |
| ByteLengthOfPayload = unit_payload_length_minus1 + 1 | |
| reserved = 0 | u(2) |
| } | |

TABLE 21

| | |
|---|---|
| Code | Descriptor |

unit_payload( ) {
payload(ByteLengthOfPayload)
}

Table 22 shows an example unit payload type registry. Some of the payload types shown in Table 22 are also shown as examples in FIG. 7.

TABLE 22

| Type | Description |
|---|---|
| 0 | Sequence Parameter Set |
| 1 | Frame Parameter Set |
| 2 | Intra-Slice |
| 3 | Inter-Slice |
| 4 | Skip-Slice |
| 5-63 | Reserved |

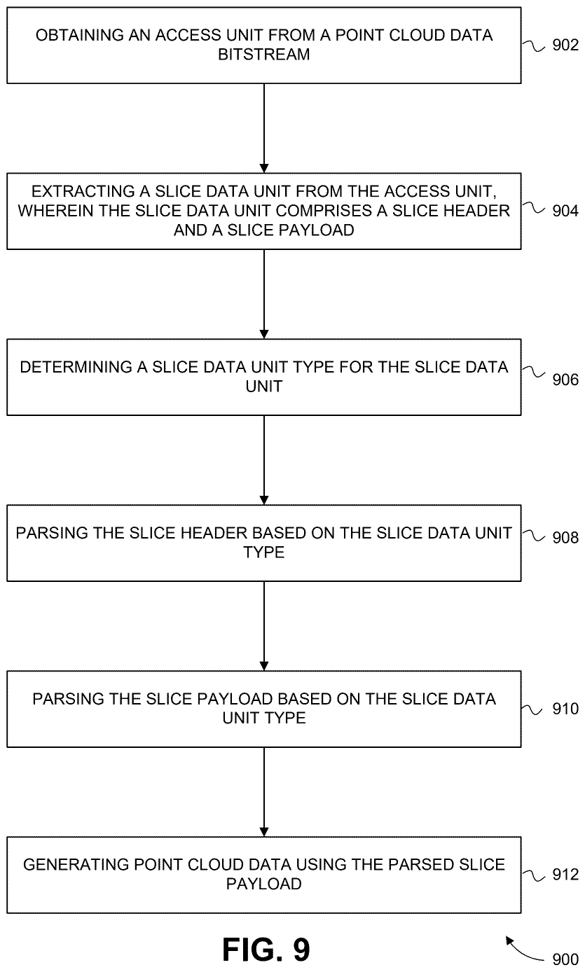

FIG. 9 is a flowchart illustrating an example process for parsing a point cloud access unit according to some embodiments. For some embodiments, an example process 900 may include obtaining 902 an access unit from a point cloud data bitstream. For some embodiments, the example process 900 may further include extracting 904 a slice data unit from the access unit, wherein the slice data unit comprises a slice header and a slice payload. For some embodiments, the example process 900 may further include determining 906 a slice data unit type for the slice data unit. For some embodiments, the example process 900 may further include parsing 908 the slice header based on the slice data unit type. For some embodiments, the example process 900 may further include parsing 910 the slice payload based on the slice data unit type. For some embodiments, the example process 900 may further include generating 912 point cloud data using the parsed slice payload.

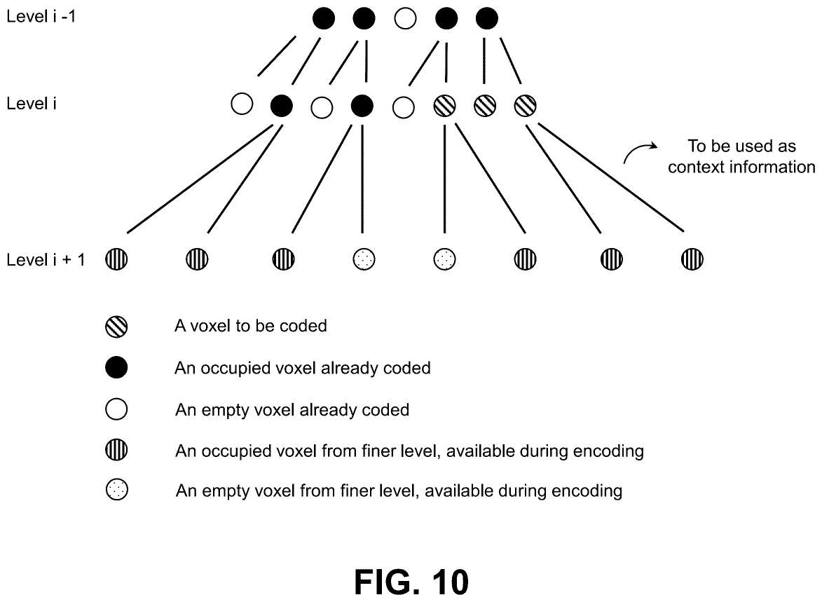

FIGS. 10-20 presented below provide non-limiting examples adapted from the '144 application. The following examples are adapted and presented from the '144 application, incorporated herein by reference, for explanatory purposes.

### Learning-Based Point Cloud Compression

Since point cloud data is composed of two components: geometry information and attribute information, the compression of point clouds can be classified into two categories: geometry coding and attribute coding.

Examples of existing learning-based point cloud geometry compression techniques are deep octree coding, end-to-end feature-based geometry coding. With deep octree coding, neural network-based models are utilized to estimate the occupancy probabilities. Such estimated probabilities are then used to help the arithmetic coder (or other entropy coder) to encode or decode a binary flag indicating whether a child octree voxel is occupied or empty.

In an octree-based representation, the whole space, i.e., a 3D bounding box, is recursively split into an octree structure to represent a point cloud. If the bounding box has a scale of 1×1×1, an octree leaf node corresponds to a point with a size equal to 1/(2^{d})×1/(2^{d})×1/(2^{d}), where index d represents the depth level in the octree counted from 0.

In an octree decomposition tree, the root node covers the whole 3D bounding box. The 3D space is equally split in every direction, i.e., x-, y-, and z-directions, leading to eight (8) voxels. For each voxel, if there are at least one point in it, the voxel is marked to be occupied, represented by ‘1’; otherwise, it is marked to be empty, represented by ‘0’. The octree root node is then described by an 8-bit integer number indicating the occupancy information.

To move from an octree level to the next, the space of each occupied voxel is further split into eight (8) child voxels in the same manner. If occupied, each child voxel is further represented by an 8-bit integer number. The splitting of occupied voxels continues until the last octree depth level is reached. The leaves of the octree finally represent the point cloud.

In accordance with presented examples, the encoding/decoding does proceed from the root level all the way down to the leaf level, i.e., it is overall still a top-down strategy. However, as, in accordance with some examples presented, the octree voxel occupancy probability is estimated using finer level of details, it is a bottom-up strategy for the encoding/decoding of each individual level. In the example methods of coding the tree structures for a point cloud, the encoder not only encodes occupancy information into the bitstream, but also encodes features, which are extracted/aggregated based on information from the finer levels of the octree, into the bitstream. Such features are used to assist the encoder to perform the arithmetic coding of the octree occupancy information. In the example method, the decoder first decodes the feature, and then decodes the octree occupancy information based on the decoded feature.

### An Example Encoding Method

FIG. 10 illustrates a portion (level i−1, i, i+1) of an octree to be coded. In FIG. 10, we use a binary tree representing an octree for a point cloud for the purpose of simplifying the drawing. A solid point represents an occupied octree voxel, that has been already encoded or decoded. A circle point represents a non-occupied or empty octree voxel, that has been already encoded or decoded. A circle with diagonal shading represents the octree voxels to be encoded or decoded.

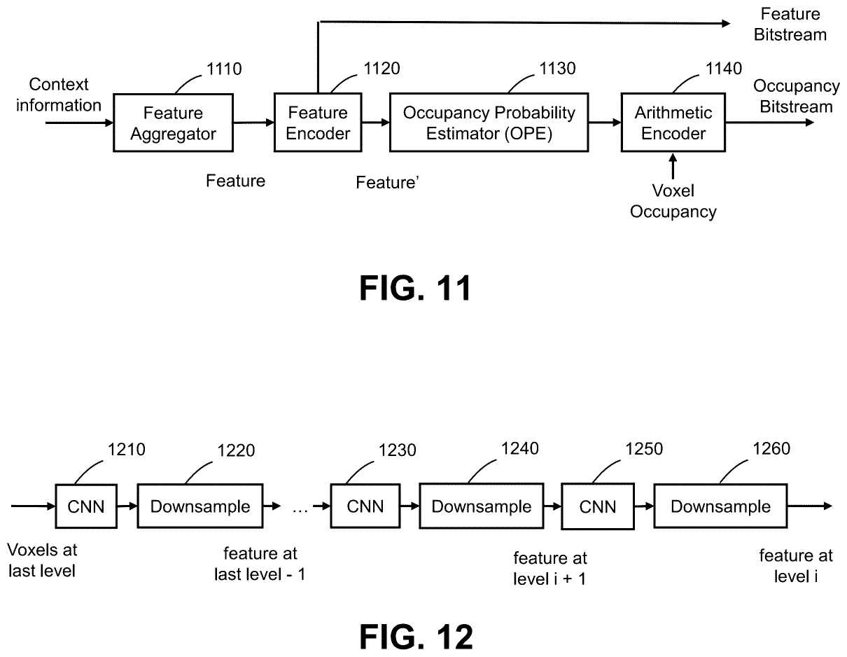

FIG. 11 illustrates an example encoding method, according to some embodiments. The example method of FIG. 11 also encodes features as well as octree occupation information.

The example feature extractor/aggregator (1110) uses the finer (child) level of details, or the complete current level (including those voxels that have not been encoded/decoded) as its input. Because the finer level of voxels or the complete current level always have more detailed information comparing to voxels from a parent level, it is much easier to extract more representative features.

Because the feature is extracted based on the finer or current level of voxels that are not yet coded, the extracted feature needs to be signaled in the bitstream. The feature generated by the feature aggregator (1110) is encoded into bitstream by a feature encoder FE (1120). In addition to generating the bitstream, the feature encoder also outputs the reconstructed feature, that may not be exactly the same as the feature from the feature aggregator (1110). The reconstructed feature should match the decoded feature on a decoder.

The occupancy probability estimator (OPE) uses a neural network model to estimate occupancy probabilities of the voxels to be encoded. It takes the reconstructed feature as its input and computes (1130) the occupancy probability of a current octree voxel. Based on the estimated probability, the arithmetic encoder (1140) will encode the occupancy information of the current octree voxel into a bitstream. In the figure, two separate bitstreams are shown for the occupancy and feature. Alternatively, they can be multiplexed into one bitstream.

### Feature Aggregator (1110)

An example feature aggregator (FA) is shown in FIG. 12 in accordance with some embodiments. The feature extraction and aggregation start from the finest level of octree. The aggregated feature undergoes a deeper network to propagate the feature all the way from the finest level to the current level.

In accordance with some embodiments, the feature aggregator (FA), includes several 3D convolutional neural network (CNN) blocks (1210, 1230, 1250) followed by downsampling (1220, 1240, 1260). The CNN module is simply composed of a series of back-to-back 3D convolutional layers with ReLU activation function appended after each convolutional layer to introduce non-linearity to the feature aggregation process. The “Downsample” blocks are to gradually downsample the feature from the last (finest) level to the i-th level. In more advanced embodiments, the CNN blocks can be replaced with other commonly used feature aggregation blocks, such as an Inception ResNet (IRN) block, and a Transformer block, and these blocks can be repeated several times to enhance the feature aggregation performance.

More generally, the feature aggregation can be based on any number of finer levels as well as the complete current level (including those voxels that have not been encoded/decoded) in the octree.

### Feature Encoder (1120)

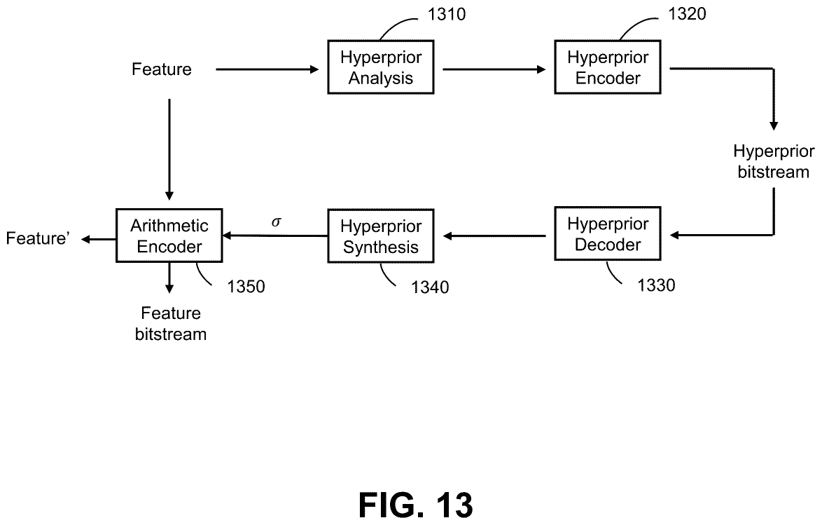

An example feature encoder (FE) is shown in FIG. 13 in accordance with some embodiments. The example feature encoder employs the hyperprior encoder. A purpose of this example design is to analyze and utilize the distribution of the feature so as to perform efficient arithmetic coding of the feature.

The input feature is sent to a “hyperprior analysis” module (1310) to aggregate a hyperprior feature that is more abstract than the input feature. The hyperprior feature is much easier to be encoded. It is used to compute the hyperprior parameters later. The hyperprior features are encoded (1320) into a hyperprior bitstream, that may undergo some quantization first and arithmetic encoding.

The hyperprior bitstream is arithmetically decoded and dequantized (1330) to output a reconstructed hyperprior feature. The reconstructed hyperprior feature is sent to a “hyperprior synthesis” module (1340) to compute the distribution parameters of the input feature. In the embodiment shown in FIG. 13, the distribution parameters include variance parameters (o) of the initial feature. In another embodiment, the distribution parameters include both the mean and the variance parameters of the initial feature.

The estimated hyperprior parameters (mean and variance) are provided to an arithmetic encoder (1350) to encode the input feature. The feature encoder with hyperprior encoder is more advanced than the feature encoder shown in FIG. 9. It can provide higher coding performance. The “hyperprior analysis” (1310) and “hyperprior synthesis” (1340) modules are typically learnable neural network modules.

### Occupancy Probability Estimator (1130)

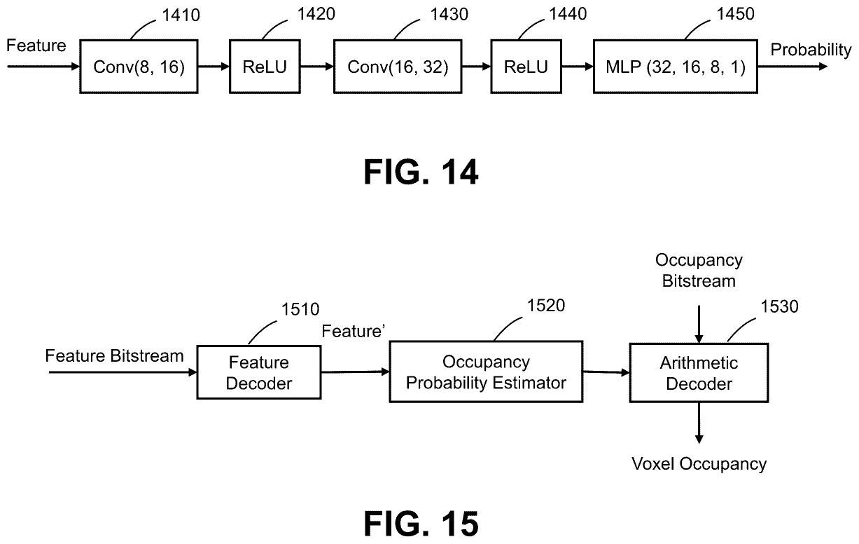

In one embodiment, an example occupancy probability estimator (OPE) is shown in FIG. 14. Firstly, the feature is further aggregated/refined by a few convolutional layers (two Conv layers, 1410, 1430), where a ReLU activation function (1420, 1440) is appended after each Conv layer to introduce non-linearity. After that, it is passed to a multilayer perceptron (MLP, 1450) to finally compute the probability. In FIG. 14, the array (32, 6, 8, 1) after MLP indicates the channel size of the MLP layers. In the end, the occupancy probability is one scalar number, therefore the output channel of the MLP is one (1).

FIG. 15 illustrates an example decoding method corresponding to the encoding method illustrated in FIG. 11, according to some embodiments. A feature decoder (FD) decodes (1510) a feature from the input bitstream. Basically, the decoder relies on a coded feature rather than to extract the feature from scratch by itself. The example decoder benefits from a more representative feature as the features were extracted using finer level of details or complete current level of detail than from the parent level. An occupancy probability estimator (OPE) computes (1520) an occupancy probability of a next octree voxel. This is the same OPE (1120) in the encoding method in FIG. 11. Based on the estimated probability, an arithmetic decoder (1530) will determine if the next octree voxel is occupied or empty.

### Feature Decoder (1510)

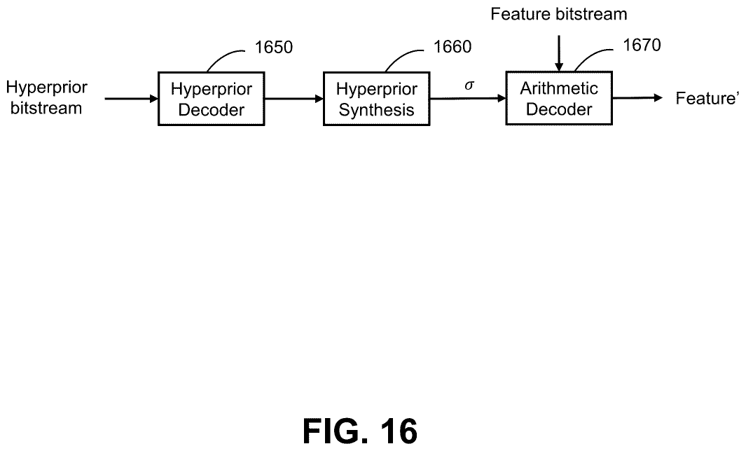

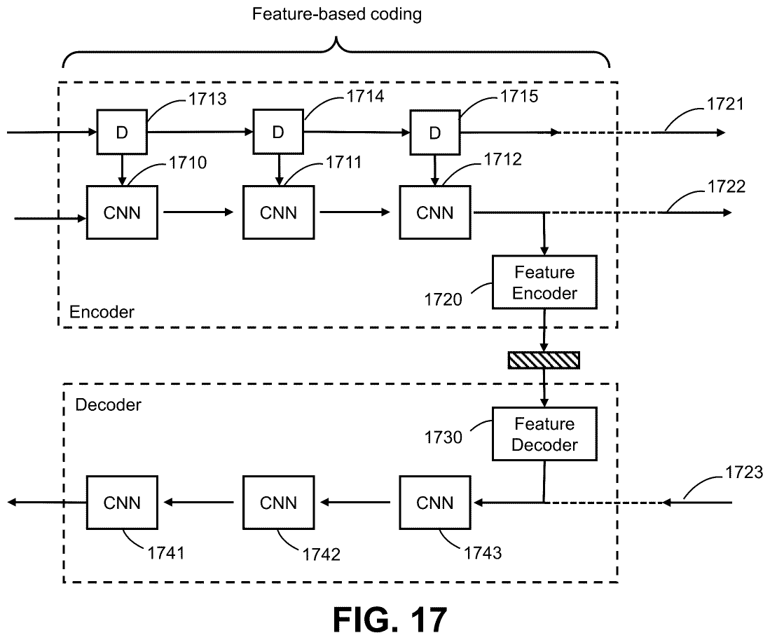

In another embodiment, an example feature decoder using hyperprior decoding is shown in FIG. 16. This decoder corresponds to the encoder as shown in FIG. 13. In particular, the coded hyperprior features is arithmetically decoded (1650) from a bitstream. The hyperprior features are sent to a “hyperprior synthesis” module (1660) to generate the distribution parameters to be used in the next step. In the embodiment shown in FIG. 16, the distribution parameters include the variance. In another embodiment, the distribution parameters include both the mean and the variance parameters. The features coded in a bitstream is arithmetically decoded (1670) based on the estimated hyperprior parameters.

Note that the “hyperprior synthesis” and “hyperprior decoder” are the same as the models at the encoder as illustrated in FIG. 13. The arithmetic decoder (1670) of feature corresponds to the feature encoder (1350) of feature at the encoder as illustrated in FIG. 13.

### Example Tree Coding in a Full Compression Framework

In the following, we present some examples regarding how example octree encoding and decoding are designed within a larger full compression framework.

In the example full point cloud compression framework, the octree-based coding is used to code the coarser level of point clouds (i.e., point cloud octree partitions) that requires lossless coding for an exact reconstruction. In one embodiment, when the example octree-based coding method is applied to code all octree levels, it leads to a lossless compression solution.

In one embodiment, as illustrated in FIG. 17 and FIG. 18 or FIG. 17 and FIG. 19, the example octree-based coding is concatenated with a feature-based coding method. It leads to an overall lossy compression solution. In particular, the coarser portion of the point cloud is encoded with octree coding and the remaining finer portion of the point cloud is encoded by feature-based coding. The occupancy information output from the final level of feature-based encoding is used as input for the octree-based encoding. The occupancy information output from the final level of octree-based decoding is used as input for feature-based decoding.

### Feature-Based Coding in the Full Compression Framework

FIG. 17 illustrates a feature-based coding method. The encoder is shown in the top part of the figures. In FIG. 17, by applying “D” (1713, 1714, 1715) to the point cloud, the point cloud at a coarser level is obtained. It has a few CNN-like neural network modules (1710, 1711, 1712). They basically extract and aggregate a feature map from the input, for example, point cloud frames. During the feature extraction and aggregation, the resolution of the input is typically downsampled via pooling operations as part of the CNN-like neural network modules. Finally, the extracted feature is sent to a “Feature Encoder” (FE) module (1720) to output a bitstream.

The decoder is shown in the bottom part of the figure. A feature decoder (1730) decodes the features from the bitstream. The decoder has a few CNN-like neural network modules (1741, 1742, 1743). They correspond to the CNN-like neural network modules (with downsampling) in the encoder. Instead of performing downsampling/pooling, the CNN-like neural network modules reconstruct the input (e.g., point cloud) from the decoded features, via upsampling/unpooling. The CNN modules can be enhanced or replaced by MLP or some other neural network modules, such as the Inception ResNet (IRN) or Transformer blocks.

### Full Compression Framework, One Example

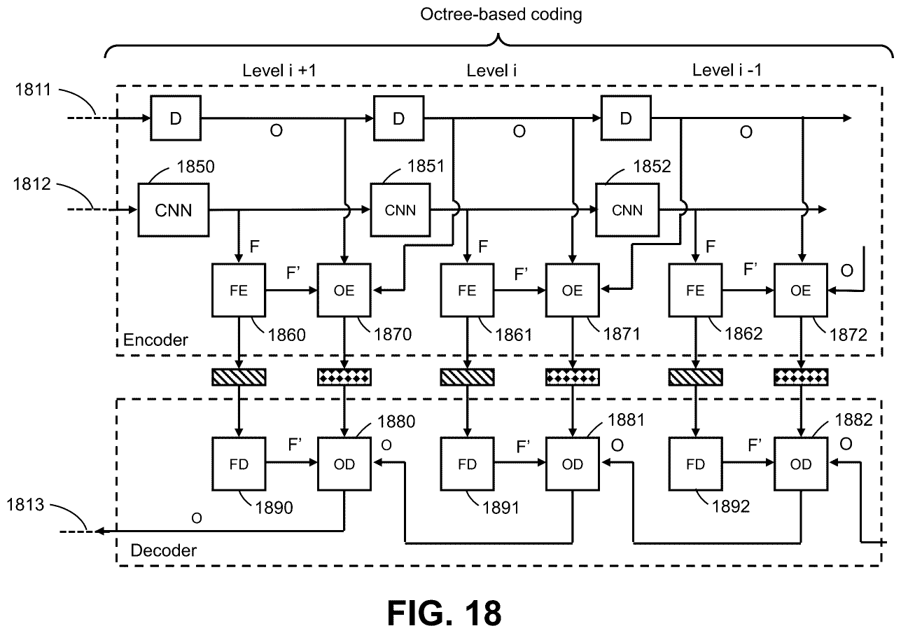

We first adopt an example octree-based compression method as shown in FIG. 11 (for encoder) and FIG. 15 (for decoder) in a full compression framework as shown in FIG. 18. In this FIG. 18, we show how the example octree-based elementary encoding and decoding modules are concatenated according to some embodiments. We note that in a full compression framework combining FIG. 17 and FIG. 18, the top (1721), middle (1722), and bottom (1723) arrows of FIG. 17 are connected to the top (1811), middle (1812), and bottom (1813) arrows of FIG. 18, respectively.

In the top of FIG. 18, we show CNN-like neural network modules being concatenated to perform feature extraction and/or aggregation (1850, 1851, 1852). Each CNN represents a neural network module to generate/aggregate a feature map that is associated with a point cloud at certain resolution. This CNN module corresponds to the feature extraction/aggregation FA module in FIG. 11.

We note that the point cloud at different levels is obtained by applying a series of downsampling blocks “D” in FIG. 18, where each downsampling block “D” downsamples the point cloud by a factor of 2. In FIG. 18, by applying “D” to the point cloud at level i+1, the point cloud at level i is obtained. Additionally, by applying “D” to the point cloud at level i, the point cloud at level i−1 is obtained. Note that “O” denotes the occupancy information and “F” denotes a feature map.

In accordance with the example shown in FIG. 18, the CNNs (1850, 1851, 1852) in the top are only used during encoding and they consecutively downsample the point cloud. This is a result that in the example octree-based coding, the features extracted by the CNNs are encoded into bitstreams. In other examples the features are not coded. Instead, the decoder runs the same feature extraction as the encoder. This is reflected by the feature encoding modules FE (1860, 1861, 1862) in FIG. 18. On decoder side, the feature is decoded by modules FD (1890, 1891, 1892). The decoded feature is used to assist the octree encoding OE (occupancy encoder) modules (1870, 1871, 1872) (e.g., OPE 1130 and AE 1140 in FIG. 11) at the encoder side and octree decoding OD modules (1880, 1881, 1882) (e.g., OPE 1520 and AD 1530 in FIG. 15). For instance, to encode the octree at level i+1, a feature map at level i+1 is extracted from level i+2 via a CNN module (1850), such feature map will be further processed by another CNN module (1851) to obtain a feature map at level i to assist the coding of level i, and it will be further propagated in the same manner to assist the octree coding of other levels.

Also note that the direction to perform feature extraction by CNNs is from left to right. It indicates that the feature extraction is based on a finer level of octree. Note all voxels in the current level may also be used since the encoder has access to the whole octree. This is in contrast to other example methods that do not transmit the feature bitstream; such methods they cannot use any voxel not yet decoded for feature extraction. We note that although the feature extraction proceeds from left to right, i.e., from a finer to a coarser level, the encoding/decoding process is to be done from right to left, i.e., from a coarser level to a finer level, because the finer level occupancy information is built on top of a known coarser level. Thus, during encoding/decoding, we first perform the feature extraction from left to right. Then we perform encoding/decoding from right to left, level-by-level, based on the extracted features.

In one embodiment, the feature outputted for use at level i is generated with every voxel that are occupied at level i. In addition, features are also generated for non-occupied voxels if its parent voxel is occupied. These features are later used by octree encoding OE and octree decoding OD to compute the occupancy probabilities of all the voxels to be encoded/decoded at level i.

### Full Compression Framework, Another Example

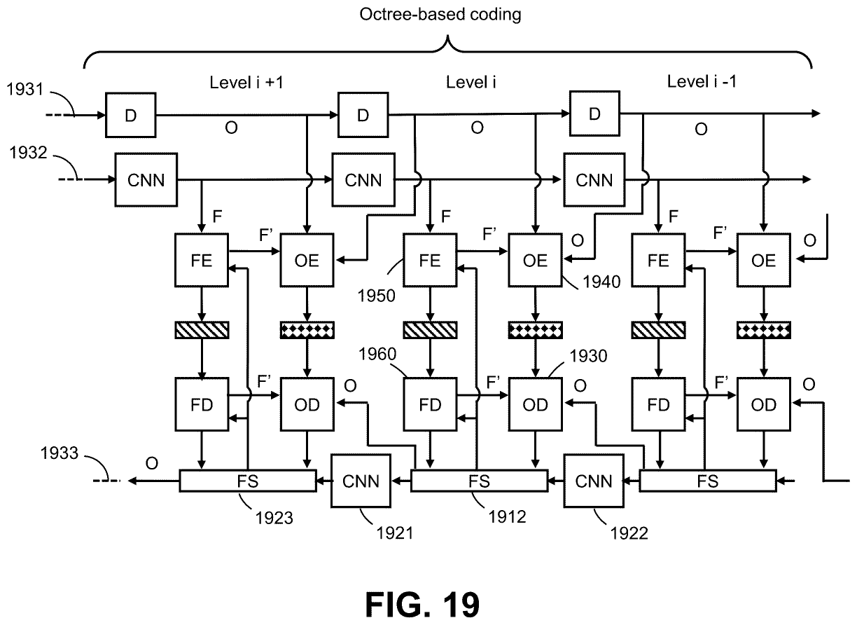

In this embodiment, another example of octree-based coding is presented in FIG. 19. This embodiment is motivated by using a different way to benefit the coding performance. We note that in a full compression framework combining FIG. 17 and FIG. 19, the top (1721), middle (1722), and bottom (1723) arrows of FIG. 17 are connected to the top (1931), middle (1932), and bottom (1933) arrows of FIG. 19, respectively.

In FIG. 19, the FS block (1912) takes the output of CNN block (1922) as input. One output of FS block (1912) is a set of estimated hyperprior parameters that is sent to feature encoding block FE (1950) and feature decoding block FD (1960). The motivation behind is to use the coded information in bitstreams from coarser levels to estimate the hyperprior parameters of the features in the current level. The idea is similar to the diagram described in FIG. 16, but the coded feature is not encoded from a hyperprior encoder but from the coded feature of the previous level. Thus, a hierarchical hyperprior model is in use to encode or decode the features.

The new FS block (1912) further takes the output of occupancy decoder OD block (1930) as its input. Finally, a second output from FS block (1912) is sent to the CNN (1921) for next level of feature aggregation.

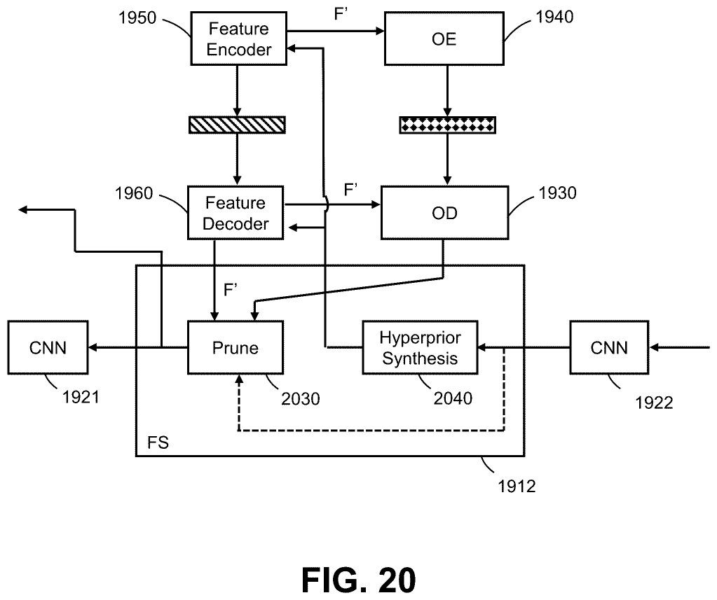

FIG. 20 shows detailed design in the FS block, according to an embodiment. First the output feature from CNN (1922) for the parent level is consumed by a hyperprior synthesis block HS (2040). The HS block outputs the hyperprior parameters, and the parameters are sent to feature encoding block FE (1950) and feature decoding block FD (1960). Then the features reconstructed from feature encoding and decoding blocks are used to assist the occupancy encoding block OE (1940) and occupancy decoding block OD (1930), respectively. We note that the FS block exists on both encoder and decoder sides. On the encoder side, it is needed to compute F′, so that F′ can be used by OE to obtain the occupancy bitstream.

The output from occupancy decoding block (1930) is the final reconstruction of point cloud at the current resolution. The reconstructed point cloud is finally used to prune (2030) the decoded features from FD block. The pruned feature is sent to the next CNN (1921) for feature aggregation when the current level is not the final level for the lossless octree coding.

In another embodiment, the prune module (2030) also takes the CNN feature as input (corresponds to the dotted line in FIG. 20). In this example, the pruning first fuses the CNN feature and the decoded feature. Then the fused feature is pruned according to the reconstructed point cloud in the current resolution.

In another embodiment, to encode or decode the feature for feature-based coding (FIG. 17), a CNN module, followed by a FS module at level i+2, are also appended after the FS module for level i+1 (1923), and the FS module at level i+2 produces hyperprior parameters to assist the encoding (1720) or decoding (1730) of the feature in the feature-based coding stage.

An example apparatus in accordance with some embodiments may include at least one processor configured to perform any one of the methods described within this application. An example apparatus in accordance with some embodiments may include a computer-readable medium storing instructions for causing one or more processors to perform any one of the methods described within this application. An example apparatus in accordance with some embodiments may include at least one processor and at least one non-transitory computer-readable medium storing instructions for causing the at least one processor to perform any one of the methods described within this application. An example signal in accordance with some embodiments may include a bitstream generated according to any one of the methods described within this application.

While the methods and systems in accordance with some embodiments are generally discussed in context of extended reality (XR), some embodiments may be applied to any XR contexts such as, e.g., virtual reality (VR)/mixed reality (MR)/augmented reality (AR) contexts. Also, although the term “head mounted display (HMD)” is used herein in accordance with some embodiments, some embodiments may be applied to a wearable device (which may or may not be attached to the head) capable of, e.g., XR, VR, AR, and/or MR for some embodiments.

A first example method in accordance with some embodiments may include: obtaining an access unit from a point cloud data bitstream; extracting a slice data unit from the access unit, wherein the slice data unit comprises a slice header and a slice payload; determining a slice data unit type for the slice data unit; parsing the slice header based on the slice data unit type; parsing the slice payload based on the slice data unit type; and generating point cloud data using the parsed slice payload.

For some embodiments of the first example method, the slice data unit type is determined to correspond to either geometry data or attribute data.

For some embodiments of the first example method, the slice payload comprises a slice geometry payload.

For some embodiments of the first example method, the slice geometry payload comprises explicit hyperprior data, and the explicit hyperprior data aggregates two or more point cloud features.

For some embodiments of the first example method, the slice payload comprises a slice geometry payload with octree occupancy data.

For some embodiments of the first example method, the slice payload comprises a slice geometry payload organized on a per-depth level basis.

For some embodiments of the first example method, parsing the slice payload comprises splitting the slice payload into two or more sub-slices.

For some embodiments of the first example method, the slice payload comprises a slice attribute payload.

For some embodiments of the first example method, the slice attribute payload comprises explicit hyperprior data and the explicit hyperprior data aggregates two or more attributes.

For some embodiments of the first example method, the slice payload comprises a slice attribute payload with octree occupancy data.

Some embodiments of the first example method further include: obtaining a parameter set from the point cloud data bitstream; extracting a parameter from the parameter set; and configuring a decoder based on the extracted parameter.

For some embodiments of the first example method, generating point cloud data using the parsed slice payload comprises synthesizing hyperprior data using the parsed slice payload.

A first example apparatus in accordance with some embodiments may include: a processor; and a memory storing instructions operative, when executed by the processor, to cause the apparatus to: obtain an access unit from a point cloud data bitstream; extract a slice data unit from the access unit, wherein the slice data unit comprises a slice header and a slice payload; determine a slice data unit type for the slice data unit; parse the slice header based on the slice data unit type; parse the slice payload based on the slice data unit type; and generate point cloud data using the parsed slice payload.

A second example method in accordance with some embodiments may include: obtaining point cloud data; segmenting the point cloud data into one or more data slices; performing a slice assembly process for each of the one or more data slices, wherein the slice assembly process performed for a current slice of the one or more data slices comprises: determining a point cloud data type for the current slice; generating a slice header for the current slice based on the point cloud data type; generating a slice payload for the current slice based on the point cloud data type; and assembling the slice header and the slice payload together as a slice data unit for the current slice; and generating an access unit using one or more of the slice data units.

For some embodiments of the second example method, the slice payload comprises one of a slice geometry payload, a slice geometry payload with octree occupancy, and a slice geometry payload organized on a per-depth level basis.

For some embodiments of the second example method, the slice payload comprises explicit hyperprior data, and the explicit hyperprior data aggregates two or more point cloud features.

For some embodiments of the second example method, the slice payload comprises point cloud data for two or more sub-slices.

For some embodiments of the second example method, the slice payload comprises one of slice geometry data and slice attribute data.

Some embodiments of the second example method further include: obtaining a parameter used for configuring a decoder; and generating a parameter set using the obtained parameter.

Some embodiments of the second example method further include streaming the access unit via a bitstream.

One or more embodiments provide a computer program comprising instructions which when executed by one or more processors cause such processors to perform the encoding and/or decoding methods according to any of the embodiments described above. One or more embodiments also provide a computer readable storage medium having stored thereon instructions for encoding or decoding video data according to the methods described above.

One or more embodiments provide a computer readable storage medium having stored thereon video data generated according to the methods described above. One or more embodiments also provide a method and apparatus for transmitting or receiving video data generated according to the methods described above.

The embodiments described herein may be implemented in, for example, a method or a process, an apparatus, a software program, a data stream, or a signal. Even if only discussed in the context of a single form of implementation (e.g., as a method), the implementation of such features may also be implemented in other forms. An apparatus may be implemented in, for example, appropriate hardware, software, and firmware. Corresponding methods may be implemented in, for example, a processor.

Various numeric values are used in the present application. Such specific values are for example purposes and the embodiments described are not limited to these specific values.

Various methods are described herein, and such methods comprise one or more steps or actions for achieving the described method. Unless a specific order of steps or actions is required for the proper operation of the method, the order and/or use of specific steps and/or actions may be modified or combined. Additionally, terms such as “first”, “second”, etc. may be used in various embodiments to modify an element, component, step, operation, etc., for example, a “first decoding” and a “second decoding”. Use of such terms does not imply an order to the operations unless specifically required.

The present disclosure may refer to “determining” various pieces of information. Determining information may include one or more of, for example, estimating, calculating, predicting, or retrieving (e.g., from memory) the information.

The present disclosure may refer to “accessing” various pieces of information. Accessing information may include one or more of, for example, receiving, retrieving (e.g., from memory), storing, moving, copying, calculating, determining, predicting, or estimating the information. Similarly, the present disclosure may refer to “receiving” various pieces of information. Receiving information may include one or more of, for example, accessing or retrieving (e.g., from memory) the information.

It is to be understood that use of any of the following “/”, “and/or”, and “at least one of” is intended to encompass all possible selections of listed items, taken either individually or in any combination thereof.

While specific embodiments have been described in the foregoing description in connection with the accompanying drawings, it should be understood that embodiments described herein are examples only and should not be taken as limiting the scope of the present disclosure or the following claims. Although features and elements are described herein in particular combinations, those of ordinary skill in the art will appreciate that such features or elements may be used alone or in any combination with the other features and elements. It is understood, therefore, that the overall teachings of the present disclosure are not limited to the particular embodiments, implementations, and examples disclosed herein, but are intended to cover variations, modifications, and alternatives as defined by the appended claims and any and all equivalents thereof.

This disclosure describes a variety of aspects, including tools, features, embodiments, models, approaches, etc. Many of these aspects are described with specificity and, at least to show the individual characteristics, are often described in a manner that may sound limiting. However, this is for purposes of clarity in description, and does not limit the disclosure or scope of those aspects. Indeed, all of the different aspects can be combined and interchanged to provide further aspects. Moreover, the aspects can be combined and interchanged with aspects described in earlier filings as well.

Various numeric values may be used in the present disclosure, for example. The specific values are for example purposes and the aspects described are not limited to these specific values.

Embodiments described herein may be carried out by computer software implemented by a processor or other hardware, or by a combination of hardware and software. As a non-limiting example, the embodiments can be implemented by one or more integrated circuits. The processor can be of any type appropriate to the technical environment and can encompass one or more of microprocessors, general purpose computers, special purpose computers, and processors based on a multi-core architecture, as non-limiting examples.

When a figure is presented as a flow diagram, it should be understood that it also provides a block diagram of a corresponding apparatus. Similarly, when a figure is presented as a block diagram, it should be understood that it also provides a flow diagram of a corresponding method/process.

The implementations and aspects described herein can be implemented in, for example, a method or a process, an apparatus, a software program, a data stream, or a signal. Even if only discussed in the context of a single form of implementation (for example, discussed only as a method), the implementation of features discussed can also be implemented in other forms (for example, an apparatus or program). An apparatus can be implemented in, for example, appropriate hardware, software, and firmware. The methods can be implemented in, for example, a processor, which refers to processing devices in general, including, for example, a computer, a microprocessor, an integrated circuit, or a programmable logic device. Processors also include communication devices, such as, for example, computers, cell phones, portable/personal digital assistants (“PDAs”), and other devices that facilitate communication of information between end-users.

Reference to “one embodiment” or “an embodiment” or “one implementation” or “an implementation”, as well as other variations thereof, means that a particular feature, structure, characteristic, and so forth described in connection with the embodiment is included in at least one embodiment. Thus, the appearances of the phrase “in one embodiment” or “in an embodiment” or “in one implementation” or “in an implementation”, as well any other variations, appearing in various places throughout this disclosure are not necessarily all referring to the same embodiment.

Additionally, this disclosure may refer to “determining” various pieces of information. Determining the information can include one or more of, for example, estimating the information, calculating the information, predicting the information, or retrieving the information from memory.

Further, this disclosure may refer to “accessing” various pieces of information. Accessing the information can include one or more of, for example, receiving the information, retrieving the information (for example, from memory), storing the information, moving the information, copying the information, calculating the information, determining the information, predicting the information, or estimating the information.

Additionally, this disclosure may refer to “receiving” various pieces of information. Receiving is, as with “accessing”, intended to be a broad term. Receiving the information can include one or more of, for example, accessing the information, or retrieving the information (for example, from memory). Further, “receiving” is typically involved, in one way or another, during operations such as, for example, storing the information, processing the information, transmitting the information, moving the information, copying the information, erasing the information, calculating the information, determining the information, predicting the information, or estimating the information.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended for as many items as are listed.

Implementations can produce a variety of signals formatted to carry information that can be, for example, stored or transmitted. The information can include, for example, instructions for performing a method, or data produced by one of the described implementations. For example, a signal can be formatted to carry the bitstream of a described embodiment. Such a signal can be formatted, for example, as an electromagnetic wave (for example, using a radio frequency portion of spectrum) or as a baseband signal. The formatting can include, for example, encoding a data stream and modulating a carrier with the encoded data stream. The information that the signal carries can be, for example, analog or digital information. The signal can be transmitted over a variety of different wired or wireless links, as is known. The signal can be stored on a processor-readable medium.

Note that various hardware elements of one or more of the described embodiments are referred to as “modules” that carry out (i.e., perform, execute, and the like) various functions that are described herein in connection with the respective modules. As used herein, a module includes hardware (e.g., one or more processors, one or more microprocessors, one or more microcontrollers, one or more microchips, one or more application-specific integrated circuits (ASICs), one or more field programmable gate arrays (FPGAs), one or more memory devices) deemed suitable by those of skill in the relevant art for a given implementation. Each described module may also include instructions executable for carrying out the one or more functions described as being carried out by the respective module, and it is noted that those instructions could take the form of or include hardware (i.e., hardwired) instructions, firmware instructions, software instructions, and/or the like, and may be stored in any suitable non-transitory computer-readable medium or media, such as commonly referred to as RAM, ROM, etc.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

1. A method comprising:
obtaining an access unit from a point cloud data bitstream;
extracting a slice data unit from the access unit,
wherein the slice data unit comprises a slice header and a slice payload;
determining a slice data unit type for the slice data unit;
parsing the slice header based on the slice data unit type;
parsing the slice payload based on the slice data unit type; and
generating point cloud data using the parsed slice payload.

2. The method of claim 1, wherein the slice data unit type is determined to correspond to either geometry data or attribute data.

3. The method of claim 1, wherein the slice payload comprises a slice geometry payload.

4. The method of claim 3,
wherein the slice geometry payload comprises explicit hyperprior data, and
wherein the explicit hyperprior data aggregates two or more point cloud features.

5. The method of claim 1, wherein the slice payload comprises a slice geometry payload with octree occupancy data.

6. The method of claim 1, wherein the slice payload comprises a slice geometry payload organized on a per-depth level basis.

7. The method of claim 1, wherein parsing the slice payload comprises splitting the slice payload into two or more sub-slices.

8. The method of claim 1, wherein the slice payload comprises a slice attribute payload.

9. The method of claim 8,
wherein the slice attribute payload comprises explicit hyperprior data and
wherein the explicit hyperprior data aggregates two or more attributes.

10. The method of claim 1, wherein the slice payload comprises a slice attribute payload with octree occupancy data.

11. The method of claim 1, further comprising:
obtaining a parameter set from the point cloud data bitstream;
extracting a parameter from the parameter set; and
configuring a decoder based on the extracted parameter.

12. The method of claim 1, wherein generating point cloud data using the parsed slice payload comprises synthesizing hyperprior data using the parsed slice payload.

13. An apparatus comprising:
a processor; and
a memory storing instructions operative, when executed by the processor, to cause the apparatus to:
obtain an access unit from a point cloud data bitstream;
extract a slice data unit from the access unit,
wherein the slice data unit comprises a slice header and a slice payload;
determine a slice data unit type for the slice data unit;
parse the slice header based on the slice data unit type;
parse the slice payload based on the slice data unit type; and
generate point cloud data using the parsed slice payload.

14. A method comprising:
obtaining point cloud data;
segmenting the point cloud data into one or more data slices;
performing a slice assembly process for each of the one or more data slices,
wherein the slice assembly process performed for a current slice of the one or more data slices comprises:
determining a point cloud data type for the current slice;
generating a slice header for the current slice based on the point cloud data type;
generating a slice payload for the current slice based on the point cloud data type; and
assembling the slice header and the slice payload together as a slice data unit for the current slice; and
generating an access unit using one or more of the slice data units.

15. The method of claim 14, wherein the slice payload comprises one of a slice geometry payload, a slice geometry payload with octree occupancy, and a slice geometry payload organized on a per-depth level basis.

16. The method of claim 14,
wherein the slice payload comprises explicit hyperprior data, and
wherein the explicit hyperprior data aggregates two or more point cloud features.

17. The method of claim 14, wherein the slice payload comprises point cloud data for two or more sub-slices.

18. The method of claim 14, wherein the slice payload comprises one of slice geometry data and slice attribute data.

19. The method of claim 14, further comprising:
obtaining a parameter used for configuring a decoder; and
generating a parameter set using the obtained parameter.

20. The method of claim 14, further comprising streaming the access unit via a bitstream.
